(19) United States
(12) Patent Application Publication
(10) Pub. No.: US 2025/0386269 A1
(43) Pub. Date: Dec. 18, 2025

(54) ELECTRONIC DEVICE, METHOD OF CONTROLLING SAME, AND MEDIUM

(71) Applicant: CANON KABUSHIKI KAISHA, Tokyo (JP)

(72) Inventor: KIYOHIRO TSUNEKAWA, Kanagawa (JP)

(21) Appl. No.: 19/232,632

(22) Filed: Jun. 9, 2025

(30) Foreign Application Priority Data
Jun. 12, 2024 (JP) 2024-095380

(51) Int. Cl. H04W 36/08; G06F 3/12; H04W 36/00; H04W 84/12

(52) U.S. Cl. CPC H04W 36/08; G06F 3/1221; G06F 3/1236; G06F 3/1286; G06F 3/1292; H04W 36/0055; H04W 84/12

(57) ABSTRACT

An electronic device that can execute communication in a first communication mode via wireless communication with an external access point and communication with an external apparatus in a second communication mode different from the first communication mode is provided. The device changes an access point of a connection destination connected with the first communication mode to another access point on a basis of a change request received from the access point, and suppresses a change of an access point of a connection destination based on the change request in a case where a connection in the first communication mode is established and the second communication mode is activated.

### BACKGROUND

### Field of the Technology

The present disclosure relates to an electronic device that can connect via a wireless LAN, a method of controlling the same, and a medium.

### Description of the Related Art

In the field of extended service sets (ESS) configured of a plurality of access points (AP), a known technology dynamically switches connection destination APs for efficient data exchange between the APs and a station (STA). When it is determined to switch the connection destination AP on the basis of the congestion of the AP the STA is connected to, the availability of other APs, the radio wave situation, and the like, the currently connected AP transmits a change connected AP request to the STA. When the STA receives the change AP request, the STA can connect to an appropriate AP by switching the connection destination AP in accordance with the request.

Japanese Patent Laid-Open No. 2021-175068 describes the following as processing for requesting a change in the connection destination from a router provided with an AP function to a currently connected wireless client. A mobile router (MR1) that can connect to a plurality of wireless clients checks whether a wireless client terminal supports IEEE 802.11v. Whether the wireless client terminal supports IEEE 802.11v is determined from an association request frame that is transmitted when the wireless client terminal wirelessly connects to the MR1. If the wireless client terminal supports IEEE 802.11v, a BSS transition management (BTM) request frame is transmitted to the corresponding wireless client terminal. A BSS transition candidate list entries field of the BTM request designates the BSSID of a master unit router RT2 as the connection destination. This prompts the connection destination of the client terminal to be switched, and the wireless client terminal switches the connection destination from the MR1 to the RT2 in accordance with the received BTM request.

In a STA, there is a state in which a problem does not occur when the AP is switched and a state in which a problem occurs when the AP is switched or when it is disconnected from the connected AP. When in the state in which a problem occurs, an AP change request may be received from an AP, and if the connection destination AP is switched in response to the request, a problem may occur in the STA.

For example, when a communication apparatus is simultaneously connected to an AP in a wireless infrastructure mode as a STA and operating as a master station for wireless communication in P2P mode to connect to a wireless slave device such as a mobile terminal apparatus, it may be preferable to suppress an operation to switch the connection destination AP. Hereinafter, the configuration of simultaneously performing wireless communication via an AP via the wireless infrastructure mode and performing wireless communication via the P2P mode may be referred to as simultaneous operation. Also, in the case of simultaneous operation, to avoid degradation of the communication performance of the communication apparatus due to interference between the wireless infrastructure mode and the P2P mode, a combination of wireless channel configurations is preferably fixed. Also, there is the issue of the wireless communication operation via the P2P mode being delayed by the operation of switching the connection destination AP. Furthermore, in the case of connections, not only via P2P mode, but via another communication medium (or communication mode) existing simultaneously with the wireless infrastructure mode, processing for communicating via the other communication medium may be delayed by processes including communication and processing for changing the AP of the wireless infrastructure mode.

### SUMMARY

The present disclosure reduces the effects on other communication modes caused by changing an access point when connecting to a connection destination of a wireless infrastructure mode.

According to one aspect of the present disclosure, an electronic device is provided that can execute communication in a first communication mode via wireless communication with an external access point and communication with an external apparatus in a second communication mode different from the first communication mode, comprising: at least one memory storing instructions; and at least one processor that is in communication with the at least one memory and that, when executing the instructions, cooperates with the at least one memory to execute processing, the processing including changing an access point of a connection destination connected with the first communication mode to another access point on a basis of a change request received from the access point, and suppressing a change of an access point of a connection destination based on the change request in a case where a connection in the first communication mode is established and the second communication mode is activated.

Features of the present disclosure will become apparent from the following description of embodiments with reference to the attached drawings. The following description of embodiments are described by way of example.

### BRIEF DESCRIPTION OF THE DRAWINGS

FIG. 1 is a diagram illustrating a system configuration example.

FIGS. 2A and 2B are diagrams illustrating MFP configuration examples.

FIGS. 3A, 3B, and 3C are diagrams illustrating examples of an operation display unit of the MFP.

FIGS. 4A and 4B are diagrams illustrating the configuration of a mobile terminal apparatus.

FIG. 5 is a configuration diagram of an access point.

FIG. 6 is a sequence diagram for describing the processing executed in response to a connection destination change request from an AP.

FIG. 7 is a flowchart for describing processing when the MFP is activated.

FIG. 8 is a sequence diagram for describing operations between the MFP, an AP 1, and a mobile terminal according to a second embodiment.

FIG. 9 is a flowchart for describing operations of the MFP according to the second embodiment.

FIG. 10 is a sequence diagram for describing operations between the MFP, the AP 1, and the mobile terminal according to a third embodiment.

FIG. 11 is a flowchart for describing operations of the MFP according to the third embodiment.

FIG. 12 is a sequence diagram for describing operations between the MFP, the AP 1, and the mobile terminal according to a fourth embodiment.

FIG. 13 is a sequence diagram for describing operations between the MFP, the AP 1, and the mobile terminal according to a fifth embodiment.

FIGS. 14A and 14B are diagrams illustrating data configuration examples of an association request frame.

FIG. 15 is a diagram illustrating a configuration example of the MFP according to a sixth embodiment.

FIG. 16 is a flowchart for describing operations of the MFP when wireless infrastructure mode and USB are simultaneously connected.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

Also, it should be understood that the present embodiment is merely an example, and specific examples of components, processing steps, display screens, and the like are not intended to limit the scope of the present disclosure.

### System Configuration

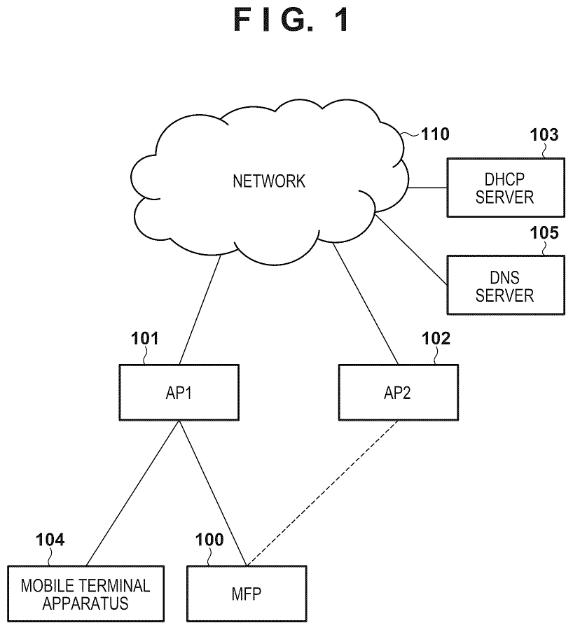

FIG. 1 is a diagram illustrating an example configuration of a system according to the present embodiment. The present system, in this example, is a wireless communication system enabling wireless communication between a plurality of communication apparatuses. In the example of FIG. 1, the communication apparatuses include a mobile terminal apparatus 104, an MFP 100, access points AP 101 and AP 102, a server 103, and a network 110.

The mobile terminal apparatus 104 is an apparatus with a wireless communication function such as wireless local area network (LAN). Note that hereinafter, wireless LAN may be referred to as WLAN. The mobile terminal apparatus 104 may be a personal digital assistant (PDA) or similar personal information terminal, a mobile phone (smartphone), a digital camera, a personal computer, or the like.

The MFP 100 is a printing apparatus with a print function and may also have a read function (scanner), a fax function, and a phone function. Also, the MFP 100 according to the present embodiment is an electronic device with a communication function enabling wireless communication with the mobile terminal apparatus 104. Also, in the present embodiment described herein, the MFP 100 is used as an example, but no such limitation is intended. For example, instead of the MFP 100, a scanner apparatus, a projector, a mobile terminal, a smartphone, a notebook PC, a tablet terminal, a PDA, a digital camera, a music playback device, a television, a smart speaker, or the like with a communication function may be used. Note that MFP is an acronym for multifunction peripheral.

The AP 1 (AP 101) operates as a WLAN base station apparatus provided separate to (outside of) the mobile terminal apparatus 104 and the MFP 100. A communication apparatus with a WLAN communication function can communicate in WLAN infrastructure mode via the AP 101. Note that hereinafter, access point may be referred to as AP. Also, infrastructure mode may be referred to as wireless infrastructure mode.

The AP 101 wirelessly communicates with a communication apparatus permitted (authenticated) to connect to it, and the communication apparatus relays wireless communication to other communication apparatuses. Also, the AP 101 may be connected to a wired communication network, for example, and relay communication between a communication apparatus connected to this wired communication network and other communication apparatuses wirelessly connected to the AP 101.

The AP 2 (AP 102) has similar functions to the AP 101, and the MFP 100 switches connection from the AP 101 to the AP 102 as necessary. The server 103 is connected to the MFP 100 via the AP 101 and the network 110 and provides a service to the MFP 100 by responding to a request from the MFP 100. Here, the network 110 may be the so-called Internet, but a closed internal company network or a cellular network may be used.

### MFP External Appearance

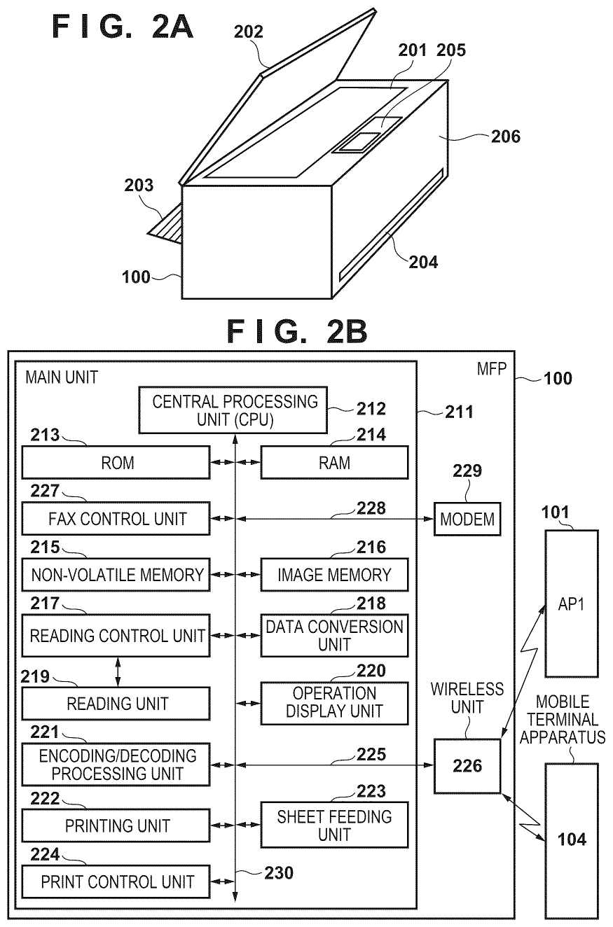

FIG. 2A illustrates an example of the external appearance of the MFP 100. The MFP 100 includes, for example, a platen 201, a document cover 202, a printing paper insertion opening 203, a printing paper discharge opening 204, and an operation display unit 205. The platen 201 is a platform for placing documents to be read. The document cover 202 is a cover used to press against a document placed on the platen 201 or prevent light from a light source illuminating the document escaping out during reading. The printing paper insertion opening 203 is an insertion opening where various sizes of sheets, that is print media, can be set. The printing paper discharge opening 204 is a discharge opening where sheets are discharged after printing. The sheets set in the printing paper insertion opening 203 are conveyed one sheet at a time to a printing unit and are discharged from the printing paper discharge opening 204 after printing has been performed by the printing unit. The operation display unit 205 includes character input keys, a cursor key, an enter key, a cancel key, and/or similar keys; LEDs; an LCD; and the like. The operation display unit 205 is configured to receive operations from the user relating to the activation of various types of functions of a MFP and various types of settings. Also, the operation display unit 205 may include a touch panel display. The MFP 100 has a WLAN wireless communication function and includes a wireless communication antenna 206 for wireless communication that is not necessarily visible from the outside. The MFP 100 can perform wireless communication via WLAN in a frequency range of the 2.4 GHz band or the 5 GHz band in a similar manner to the mobile terminal apparatus 104.

### MFP Configuration

FIG. 2B illustrates an example of the configuration of the MFP 100. The MFP 100 includes a mainboard 211 for performing main control of the apparatus itself and a wireless unit 226, which is a single communication module for performing WLAN communication using at least one shared antenna. Also, the MFP 100 includes a modem 229 for performing wired communication, for example. The mainboard 211 includes, for example, a CPU 212 (central processing unit), a ROM 213, a RAM 214, a non-volatile memory 215, an image memory 216, a reading control unit 217, a data conversion unit 218, a reading unit 219, and an encoding/decoding processing unit 221. Also, the mainboard 211 includes, for example, a printing unit 222, a sheet feeding unit 223, a print control unit 224, and an operation display unit 220. These functional units in the mainboard 211 are connected to one another via a system bus 230 managed by the CPU 212. Also, the mainboard 211 and the wireless unit 226 are connected via a dedicated bus 225, for example, and the mainboard 211 and the modem 229 are connected via a bus 228, for example.

The CPU 212 is a system control unit including at least one processor that controls the entire MFP 100. The processing of the MFP 100 described below is, for example, implemented by the CPU 212 executing programs stored in the ROM 213. Note that dedicated hardware may be prepared for each item of processing. ROM 213 stores control programs executed by the CPU 212, embedded OS programs, and the like. In the present embodiment, in a similar manner, the CPU 212 executes the control programs stored in the ROM 213 under the management of the embedded OS stored in the ROM 213 to perform software control such as scheduling and task switching. Note that the CPU 212 may load a program stored in a storage medium such as the ROM 213, the non-volatile memory 215, or the like onto the RAM 214 and execute the program.

The RAM 214 is constituted by an SRAM or the like. The RAM 214 stores data such as program control variables and the like, setting values registered by the user, MFP 100 management data, and the like. Also, the RAM 214 may be used as a buffer for various types of work. The non-volatile memory 215 is constituted by memory such as flash memory, for example, and continually stores data even after power to the MFP 100 is turned off. The image memory 216 is constituted by a memory such as a DRAM. The image memory 216 stores image data received via the wireless unit, image data processed by the encoding/decoding processing unit 221, and the like. Note that the memory configuration of the MFP 100 is not limited to the configuration described above. The data conversion unit 218 analyzes data of various formats, converts image data into print data, and the like.

The reading control unit 217 controls the reading unit 219 (for example, a contact image sensor (CIS)) to optically read the document placed on the platen 201. The reading control unit 217 converts the image obtained by optically reading the document into electrical image data (an image signal) for output. The reading control unit 217 may perform various types of processing such as binarization processing and halftone processing at this time and then output the image data.

The operation display unit 220 is the operation display unit 205 described with reference to FIG. 2A and displays to a display according to display control by the CPU 212 and generates signals in accordance with received user operations.

The encoding/decoding processing unit 221 performs encoding processing and decoding processing and enlargement and reduction processing of image data (JPEG, PNG, and the like) handled by the MFP 100.

The sheet feeding unit 223 holds sheets for printing. The sheet feeding unit 223 can supply sheets that have been set under the control of the print control unit 224. The sheet feeding unit 223 may include a plurality of sheet feeding units for holding a plurality of types of sheets in one apparatus and can control which sheet feeding unit to feed from under the control of the print control unit 224.

The print control unit 224 executes various types of processing such as smoothing processing, print density correction processing, and color correction on the image data to be printed and outputs post-processing image data to the printing unit 222. The printing unit 222 is configured to execute an inkjet printing process by discharging ink supplied from ink tanks from a print head and printing an image on a printing medium such as a sheet. Note that the printing unit 222 may be configured to execute an electro-photographic or other printing process. Also, the print control unit 224 may periodically read out information of the printing unit 222 and update status information such as ink tank remaining amount, print head state, and the like stored in the RAM 214.

The wireless unit 226 is a unit that can provide a WLAN communication function and, for example, can provide a function similar to a combination with a WLAN unit 401 of the mobile terminal apparatus 104. In other words, the wireless unit 226, following a WLAN protocol, converts data into packets and transmits packets to other devices or restores packets from other external devices into the original data and outputs them to the CPU 212. The wireless unit 226 can communicate as a station compliant with the IEEE 802.11 standard series. In particular, communication is possible as a station compliant with IEEE 802.11a/b/g/n/ac/ax. Hereinafter, station may be referred to as STA. Also, communication is possible as a STA supporting Wi-Fi Agile Multiband (trademark).

The wireless unit 226 supports IEEE 802.11ax, that is, Wi-Fi 6 (trademark). The MFP 100 can also operate as a STA that supports Orthogonal Frequency-Division Multiple Access (OFDMA) and Target Wake Time (TWT). As TWT is supported, the data communication timing from the master unit to the STA is adjusted. The wireless unit 226 (MFP 100), which is a STA, transitions the communication function to a sleep state when signal reception standby is not required. This can reduce power consumption. Also, the wireless unit 226 also supports Wi-Fi 6E (trademark). In other words, communication in the 6 GHz band (5.925 GHz to 7.125 GHz) can be performed. The target band for dynamic frequency selection (DFS) in the 5 GHz band is not in the 6 GHz band. Thus, with communication in the 6 GHz band, communication disconnections due to DFS standby time do not occur. Thus, better communication can be expected.

Note that the mobile terminal apparatus 104 and the MFP 100 can perform P2P (WLAN) communication based on Wi-Fi DIRECT (registered trademark, abbreviated to WFD), and the wireless unit 226 has a software access point (software AP) function or a group owner function. In other words, the wireless unit 226 can configure a P2P communication network, determine a channel to use for P2P communication, and the like. The MFP 100 further includes a FAX control unit 227 that controls facsimile machine transmitting and receiving. Note that P2P communication here is communication between slave devices (STAs) connected via WFD, for example, and not via an AP.

### MFP Operation Display Unit

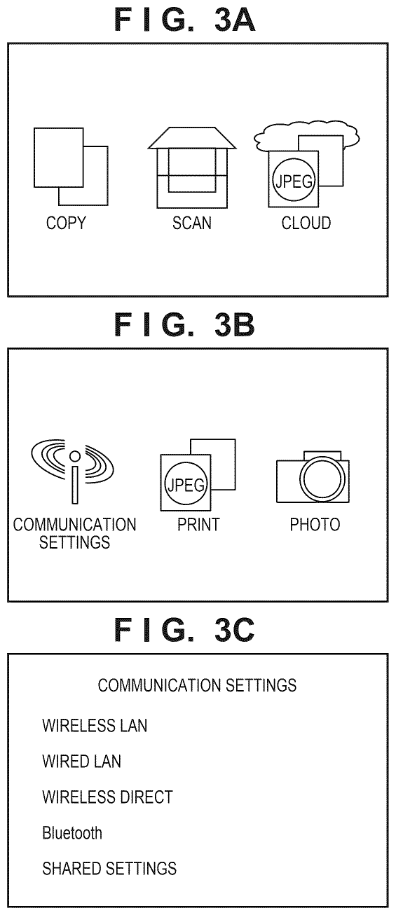

FIGS. 3A to 3C schematically illustrate example of a screen display on a display (touch panel display) including in the operation display unit 220 of the MFP 100. FIG. 3A is an example of a home screen displayed when the power of the MFP 100 is turned on and no operations such as printing or scanning are being performed (idle state, standby state). In FIG. 3A, display items (menu items) corresponding to copy, scan, and cloud are displayed. Cloud is a menu item relating to a cloud function using Internet communication. When one of the menu items is selected via operation of a key or the touch panel, the MFP 100 may start executing the corresponding setting or function. The MFP 100 can seamlessly display a screen different from that of FIG. 3A when a key or touch panel operation on the home screen of FIG. 3A is received.

FIG. 3B is an example of a display of another part of the home screen and is a screen transitioned to from the state of FIG. 3A via an operation (left or right slide operation or the like) to display another page of the home screen. In FIG. 3B, display items (menu items) corresponding to communication settings, print, and photo are displayed. When one of these menu items is selected, the function corresponding to the selected menu item, that is, the print function, the photo function, or the communication settings, is executed.

FIG. 3C is an example of a display of a menu screen for communication settings displayed when communication settings is selected on the screen of FIG. 3B. On the menu screen for communication settings, “Wireless LAN”, “Wired LAN”, “Wireless Direct”, “Bluetooth (registered trademark)”, and “Shared” are displayed as menu items (options). “Wireless LAN”, “Wired LAN”, and “Wireless Direct” are menu items for LAN settings, and from these items, wired connection settings, wireless infrastructure mode enabled/disabled setting, WFD, softAP mode, or similar P2P mode enabled/disabled setting, and the like can be set. When the “Wireless LAN” item is selected and wireless LAN is set to enabled by a user operation, the wireless infrastructure mode is enabled. When the “Wireless Direct” item is selected and wireless direct is set to enabled by a user operation, the P2P (WLAN) mode is enabled. With wireless direct or P2P (WLAN) mode or WFD, the MFP 100 functions as a master station and is connected to the slave station via P2P. On this screen, a shared settings menu relating to each connection state is also displayed. Also, the user can set the wireless LAN frequency range and frequency channel and the like from this screen.

### Mobile Terminal Apparatus External Appearance

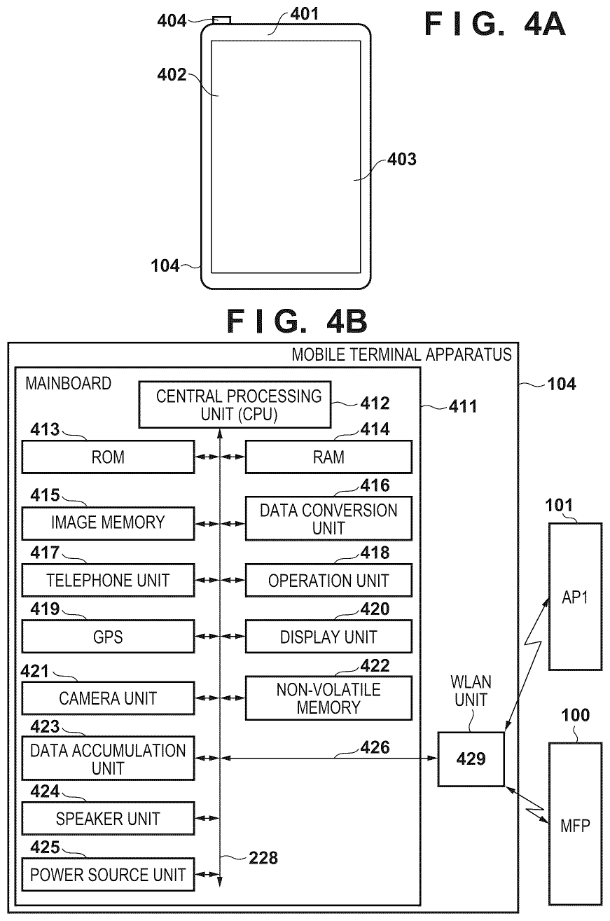

FIG. 4A is a diagram illustrating an example of the external appearance configuration of the mobile terminal apparatus 104. In the present embodiment, in this example, the mobile terminal apparatus 104 is a typical type of smartphone. Note that the mobile terminal apparatus 104, for example, includes a display portion 402, an operation portion 403, and a power key 404. The display portion 402 is a display including a liquid crystal display (LCD) display mechanism, for example. Note that the display portion 402 may display information using a light-emitting diode (LED), for example. Also, the mobile terminal apparatus 104 may have a function of outputting information via audio in addition to or instead of the display portion 402. The operation portion 403 includes physical keys such as keys and buttons, a touch panel, and the like for detecting a user operation. Note that in the present example, since displaying information on the display portion 402 and receiving user operation via the operation portion 403 is performed using a common touch panel display, the display portion 402 and the operation portion 403 is implemented using a single apparatus. In this case, for example, button icons and a software keyboard are displayed using a display function via the display portion 402, and the user touching these sections is detected by an operation reception function via the operation portion 403. Note that the display portion 402 and the operation portion 403 may be separated, and a piece of hardware for display and a piece of hardware for operation reception may be individually prepared. The power key 404 is a physical key for receiving a user operation for turning the power of the mobile terminal apparatus 104 on or off.

The mobile terminal apparatus 104 includes a WLAN unit 429 that provides a WLAN communication function and is not necessarily visible from the outside (see FIG. 4B). The WLAN unit 429 is configured to execute data (packet) communication in a WLAN system compliant with the IEEE 802.11 standard series (IEEE 802.11a/b/g/n/ac/ax and the like), for example. Also, communication is possible as an AP supporting Wi-Fi Agile Multiband. However, no such limitation is intended, and the WLAN unit 429 may be configured to execute WLAN communication compliant with another standard. Note that in this example, the WLAN unit 429 can communicate on both a 2.4 GHz frequency band channel and a 5 GHz frequency band channel. Also, the WLAN unit 429 can execute communication based on WFD, communication using a SoftAP mode, communication using a wireless infrastructure mode, and the like. Operations in these modes will be described below.

### Mobile Terminal Apparatus Configuration

FIG. 4B illustrates an example of the configuration of the mobile terminal apparatus 104. The mobile terminal apparatus 104 in this example includes a mainboard 411 for executing main control of the apparatus itself and the WLAN unit 429 for WLAN communication. The mainboard 411 includes, for example, a CPU 412, a ROM 413, a RAM 414, an image memory 415, a data conversion unit 416, a telephone unit 417, a GPS 419, a camera unit 421, a non-volatile memory 422, a data accumulation unit 423, a speaker unit 424, and a power source unit 425. Here, CPU is an acronym for central processing unit, ROM is an acronym for read only memory, RAM is an acronym for random access memory, and GPS is an acronym for global positioning system. The mobile terminal apparatus 104 also includes a display unit 420 and an operation unit 418. Each functional unit in the mainboard 411 is connected to one another via a system bus 428 managed by the CPU 412. Also, the mainboard 411 and the WLAN unit 401 are connected via a dedicated bus 426, for example.

The CPU 412 is a system control unit including at least one processor that controls the entire mobile terminal apparatus 104. The processing of the mobile terminal apparatus 104 described below is, for example, implemented by the CPU 412 executing programs stored in the ROM 413. Note that dedicated hardware may be prepared for each item of processing. The ROM 413 stores a control program executed by the CPU 412, an embedded operating system (OS) program, and the like. In the present embodiment, in a similar manner, the CPU 412 executes the control programs stored in the ROM 413 under the management of the embedded OS stored in the ROM 413 to perform software control such as scheduling and task switching.

The RAM 414 is constituted by a Static RAM (SRAM) or the like. The RAM 414 stores data such as program control variables and the like, setting values registered by the user, mobile terminal apparatus 104 management data, and the like. Also, the RAM 414 may be used as a buffer for various types of work. The image memory 415 is constituted by a memory such as a Dynamic RAM (DRAM). The image memory 415 temporarily stores image data received via the WLAN unit 429 and image data read out from the data accumulation unit 423 for processing by the CPU 412. The non-volatile memory 422 is constituted by memory such as flash memory, for example, and continually stores data even after power to the mobile terminal apparatus 104 is turned off. Note that the memory configuration of the mobile terminal apparatus 104 is not limited to the configuration described above. For example, the image memory 415 and the RAM 414 may be shared, and data backup and the like may be performed using the data accumulation unit 423. Also, in the present embodiment, DRAM was given as an example of the image memory 415. However, another storage medium such as a hard disk or a non-volatile memory may be used.

The data conversion unit 416 executes analysis of data of various formats and data conversion, such as color conversion and image conversion. The telephone unit 417 performs control of a telephone line and implements telephone communication by processing audio data input/output via the speaker unit 424. The GPS 419 receives radio waves sent from satellites and obtains position information, for example the current latitude and longitude of the mobile terminal apparatus 104.

The camera unit 421 has a function of electronically recording and encoding an image input via a lens. The image data obtained via image capture by the camera unit 421 is stored in the data accumulation unit 423. The speaker unit 424 performs control to implement a function of inputting or outputting audio for the telephone function, as well as an alarm notification and the like. The power source unit 425 is a portable battery that controls power supply to the apparatus, for example. Power source states include, for example, a battery dead state in which the battery has no remaining amount, a power-off state in which the power key 404 is not pressed, an active state in which the apparatus is normally active, and a power saving state in which the apparatus is active but is set in a power saving mode.

The display unit 420 corresponds to the display portion 402 described with reference to FIG. 4A and displays various types of input operations, the operation situation of the MFP 100, status situations, and the like on the basis of control by the CPU 412. The operation unit 418 corresponds to the operation portion 403 described with reference to FIG. 4A and performs control including generating an electrical signal corresponding to a received user operation and outputting the electrical signal to the CPU 412.

The mobile terminal apparatus 104 can perform wireless communication using the WLAN unit 429 and communicate data with another device such as the MFP 100. The WLAN unit 429 converts the data into packets and transmits the packets to the other device. Also, the WLAN unit 429 restores a packet from an external other device into the original data and outputs this to the CPU 412. The WLAN unit 429 is a unit for implementing communication compliant with the WLAN standards. The WLAN unit 429 can operate in at least two communication modes in parallel, the at least two communication modes including wireless infrastructure mode and P2P (WLAN) mode. Note that the frequency range used in these communication modes may be restricted by the functions and performance of the hardware.

### Access Point Configuration

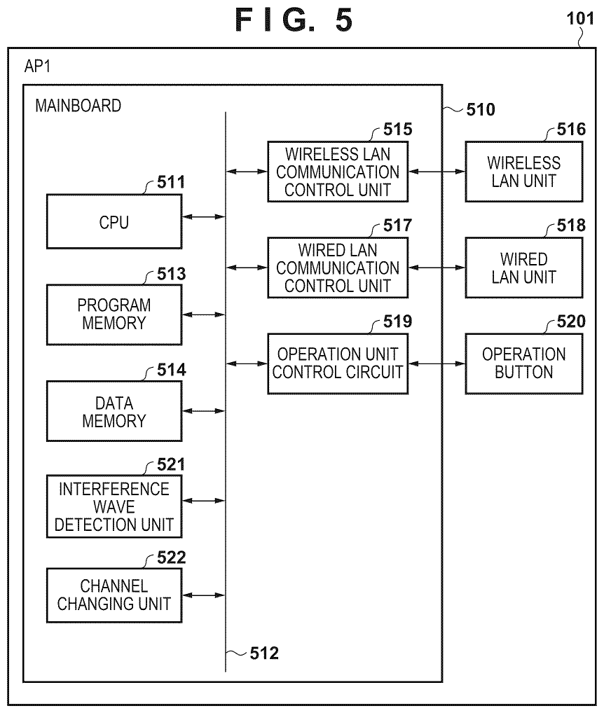

FIG. 5 is a block diagram illustrating the configuration of the AP 101 with a wireless LAN access point function. The AP 101 includes a mainboard 510 for performing control of the AP 101, a wireless LAN unit 516, a wired LAN unit 518, and an operation button 520.

A CPU 511 in the form of a microprocessor disposed on the mainboard 510 operates according to a control program stored in a program memory 513 in the form of ROM connected via an internal bus 512, the content of a data memory 514 in the form of RAM, and the like. The CPU 511 performs wireless LAN communication with other communication terminal apparatuses by controlling the wireless LAN unit 516 via a wireless LAN communication control unit 515. Also, the CPU 511 performs wired LAN communication with other communication terminal apparatuses by controlling the wired LAN unit 518 via a wired LAN communication control unit 517. The CPU 511 can receive operations from the user via the operation button 520 by controlling an operation unit control circuit 519. The CPU 511 includes at least one processor.

Also, the AP 101 includes an interference wave detection unit 521 and a channel change unit 522. The interference wave detection unit 521 executes interference detection processing during wireless communication in a band where dynamic frequency selection (DFS) is performed. The channel change unit 522 executes processing to change the channel to use when an interference wave is detected, when an empty channel needs to be immediately changed to, and the like during wireless communication in a band where DFS is performed. Note that the AP 102 has a configuration similar to that of the AP 101.

### P2P Communication Method

Next, in WLAN communication, the P2P (WLAN) communication method for apparatuses to wirelessly communicate directly bypassing an external access point will be described. P2P (WLAN) communication can be implemented using a plurality of methods. For example, a communication apparatus can support a plurality of modes for P2P (WLAN) communication and can perform P2P (WLAN) communication selectively using one of the plurality of modes.

The following two modes are examples of P2P modes.
SoftAP mode
Wi-Fi Direct (WFD) mode

The communication apparatus that can execute P2P communication may be configured to support at least one of the plurality of modes. On the other hand, a communication apparatus that can perform P2P communication does not mean that all of the modes are supported, and the communication apparatus may be configured to only support a portion of the modes.

With a communication apparatus (for example, the mobile terminal apparatus 104) having a communication function using WFD, when a user operation is received via the operation unit, an application (dedicated is some cases) for implementing the communication function is invoked. Then, the communication apparatus displays a user interface (UI) screen provided by the application and prompts for a user operation. WFD communication may be performed on the basis of the user operation received in response to this.

### SoftAP Mode

In softAP mode, the communication apparatus (for example, the mobile terminal apparatus 104) operates as a client that requests the various types of service. Another communication apparatus (for example, the MFP 100) operates as a soft AP that can execute a WLAN AP function set by the software. Note that it is sufficient that the commands and parameters transmitted and received when establishing a wireless connection between the client and the soft AP are as specified by Wi-Fi (registered trademark) standards, and thus description thereof will be omitted. Also, the MFP 100 that operates in the softAP mode determines the frequency band and the frequency channel as a master station. Thus, the MFP 100 can select which frequency range to use from among the 5 GHz frequency band and the 2.4 GHz frequency band and which frequency channel to use in the frequency band.

### WFD Mode

The MFP 100 may be configured to constantly active as a WFD mode master station (autonomous group owner). This make Go Negotiation processing for determining roles unnecessary. Also, in this case, the MFP 100 determines the frequency band and the frequency channel as a master station. Thus, the MFP 100 can select which frequency range to use from among the 5 GHz frequency band and the 2.4 GHz frequency band and which frequency channel to use in the frequency band.

### Wireless Infrastructure Mode

In the wireless infrastructure mode, the communication apparatuses (for example, the mobile terminal apparatus 104 and the MFP 100) that communicate with one another are connected to an external AP (for example, the AP 101) controlling the network, and communication between the communication apparatuses is performed via the AP. In other words, communication between the communication apparatuses is performed via the network formed by the external AP. The mobile terminal apparatus 104 and the MFP 100 each discover the AP 101, transmit a connection request to the AP 101, and connect to the AP 101. This enables communication between the communication apparatuses in the wireless infrastructure mode via the AP 101. Note that the plurality of communication apparatuses may connect to different APs. In this case, the communication apparatuses can communicate by data being transferred between APs. Note that it is sufficient that the commands and parameters transmitted and received when the communication apparatuses communicate via the access point are as specified by Wi-Fi standards, and thus description thereof will be omitted. Also, in this case, the AP 101 determines the frequency band and the frequency channel. Thus, the AP 101 can select which frequency range to use from among the 5 GHz frequency band, the 2.4 GHz frequency band, and the 6 GHz frequency band and which frequency channel to use in the frequency band.

Processing in Response to Request to Change Connection Destination from AP to STA

The mobile terminal apparatus 104 and the MFP 100 support a function released as Wi-Fi Agile Multiband (registered trademark). Wi-Fi Agile Multiband is a function that enables the optimal environment to be selected according to the changing situation of the Wi-Fi network. Specifically, a STA such as the mobile terminal apparatus 104 and the MFP 100 and an AP such as the AP 101 exchange information relating to the network environment using the IEEE 802.11 series communication standard. By exchanging such information, when the network is congested, the AP can guide (change the connection destination) of the STA to another cellular service depending on the other AP, the frequency band, the channel, and the like. Agile Multiband may be referred to as a function for changing the connection destination access point according to a change request from an AP.

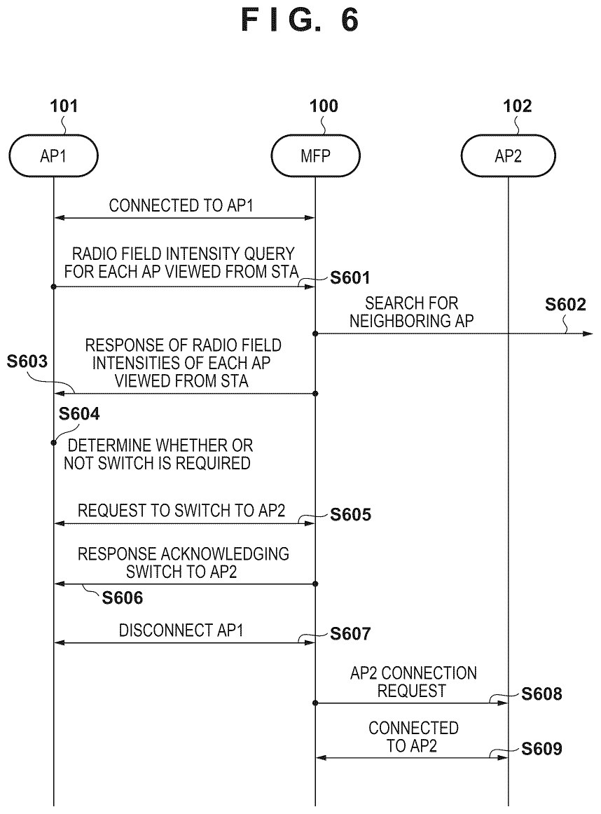

FIG. 6 is a sequence diagram of a case where the AP which is the connection destination of the MFP 100 is switched from the AP 101 to the AP 102 according to a request to change the connection destination from the AP 101. The processing executed by each apparatus in the present sequence is implement by the CPU of each apparatus reading out to the RAM and executing various types of programs stored in the ROM or similar memory of each apparatus.

In the initial state of the processing of FIG. 6, the MFP 100 has established a connection with the AP 101 in the wireless infrastructure mode. Also, when the MFP 100 and the AP 101 connect in the wireless infrastructure mode, information of whether or not the MFP 100 supports IEEE 802.11v is obtained by the AP 101. Then, if information indicating that the MFP 100 supports IEEE 802.11v is obtained, the following processing is executed.

In S601, the AP 101 transmits a query (measurement request) for the radio field intensity of the APs around the MFP 100 to the MFP 100. The request may be transmitted including, for example, a beacon frame request or a beacon report request. In other words, the request can use a mechanism specified in the IEEE 802.11k standard.

In S602, in response to the request received in S601, the MFP 100 receives the frames transmitted by the APs in the surroundings and measures the radio field intensity. Accordingly, the radio field intensity of each one of a plurality of APs including the AP 101 and the AP 102 is measured.

In S603, the MFP 100 transmits a list of the radio field intensities of the APs surrounding the MFP 100 measured in S602 as a response to the request received in S601. Note that as the radio field intensity response, in addition to or alternatively to the information measured in S602, information stored in the RAM 214, the non-volatile memory 215, or the like of the MFP 100 may be used. The response is transmitted including a beacon report or a measurement report, for example.

In S604, the AP 101 determines whether or not a switch of the connection destination of the MFP 100 is required on the basis of the congestion status of the network obtained by the AP 101 and the radio field intensities received in S603 from the MFP 100. Causes of the AP 101 determining that a connection switch is required may include there being many connection STAs, there being a large communication amount, another AP being not congested, whether or not there are congested radio waves, stoppage of the AP function, and the like. If it is determined that a switch of the connection destination of the MFP 100 is required, the SSID of the other AP designated as the post-switch connection destination of the MFP 100, the channel, and the frequency band are determined. Then, the processing proceeds to S605.

In S605, the AP 101 transmits an AP change request (connection destination switch request or switch request) to the MFP 100. The connection destination change request includes information of the SSID of the other AP designated as the switch destination for the MFP 100, the channel, and the frequency band determined in S604. Note that a plurality of SSIDs may be designated. The connection destination change request is transmitted as a BTM request, for example. In other words, a BSS transition management (BTM) request frame specified by the IEEE 802.11v standard is transmitted. In the example of FIG. 6, the AP 102 is designated as a switch destination included in the connection destination change request.

In S606, if following the connection destination change request received in S605, the MFP 100 transmits a response indicating switch acknowledgement to the AP 101. In a case where the connection destination change request is not followed, a switch rejection is transmitted as a response. The response is transmitted as a BTM response. In the example of FIG. 6, a response indicating acknowledgement is transmitted.

In S607, the AP 101 and the MFP 100 disconnect their connection in the wireless infrastructure mode, with the connection being immediately cancelled.

In S608, the MFP 100 transmits a connection request to the AP 102 to connect to the AP 102 designated in the connection destination change request received in S605.

Accordingly, in S609, the MFP 100 and the AP 102 establish a connection in the wireless infrastructure mode.

In this manner, the MFP 100 (STA) can change the connection destination from the AP 101 to the AP 102 on the basis of a connection destination change request from the originally connected AP 101. The AP 101 and the AP 102 may be APs installed at different places. In other words, the MFP 100 can switch to another AP installed at a location different from that of the originally connected AP via the processing of FIG. 6. Also, the AP may support each different frequency bands of the plurality of frequency bands (two or three of the 2.4 GHz band, the 5 GHz band, and the 6 GHz band) provided by the same device. In other words, the MFP 100 can switch to a different frequency band provided by the same apparatus as the originally connected AP via the processing of FIG. 6.

### AP Activation Control by MFP

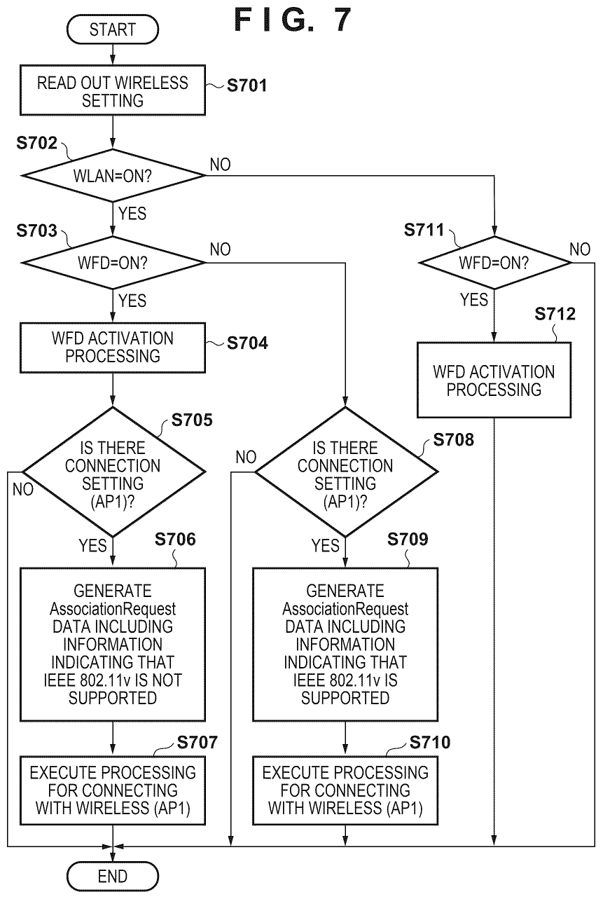

An embodiment of the present disclosure will be described below with reference to FIG. 7 and the like. In the present description, Wi-Fi Agile Multiband is referred to as Agile Multiband. Even in a case where the MFP 100 according to the present embodiment is set to accept a connection destination change request from the AP 101, if the connection mode or state of the MFP 100 satisfies a predetermined condition, the MFP 100 may operate to not accept a connection destination change request from the AP 101. In the present embodiment, a case where the MFP 100 is set to accept a connection destination change request is, the AP 101 is in a state of having recognized that the MFP 100 supports IEEE 802.11v and the Agile Multiband function is enabled.

Activation Processing when Wireless Infrastructure Mode and P2P Mode Operate Simultaneously

FIG. 7 is a flowchart for describing the operations of the MFP 100 for not accepting a connection destination change request from the AP 101 in a case where the setting satisfies a predetermined condition at the time of activation of the MFP 100 according to the present embodiment. Specifically, in the present embodiment, in a case where simultaneous operation of a wireless infrastructure mode and a P2P mode such as WFD is enabled, the MFP 100 operates to not accept a connection destination change request. Note that the processing illustrated in the present flowchart may be implemented by the CPU 212 reading out various types of programs stored in a memory such as the ROM 213 provided in the MFP 100 to the RAM 214 and executing the programs. Also, processing relating to the initialization other than the communication setting at the time of activation not relating to the present disclosure will not be described.

First, in step S701, the CPU 212 obtains a setting value relating to the operation mode of the wireless communication stored in the non-volatile memory 215. The setting value corresponds to a menu item of the communication settings illustrated in FIG. 3C, and a value indicating whether the communication mode is enabled or disabled depending on a user operation on the operation display unit 220 is able to be stored by the CPU 212. Also, in the case of a previously connected AP, wireless parameters such as a passkey used in wireless connection and the like may also be stored in the non-volatile memory 215 together.

In step S702, the CPU 212 determines whether or not the communication setting “Wireless LAN” is in the enabled state. If it is determined to be in the enabled state (yes in step S702), in step S703, the CPU 212 determines whether or not “Wireless Direct” is enabled. Note that in the following description of the present embodiment, “Wireless Direct” operates in the WFD mode, but no such limitation is intended.

In a case where both the “Wireless LAN” setting and the “Wireless Direct” setting are determined to be enabled (yes in step S703), the condition for simultaneous operation is established. Accordingly, the MFP 100 operates as a master station in the WFD mode and executes processing to connect to the AP 101 with Agile Multiband in a disabled state. Here, in step S704, the CPU 212 controls the wireless unit 226 and executes activation processing to operate as a master station in the P2P mode, and here in particular, in the WFD mode. In the WFD mode according to the present embodiment, in the 2.4 GHz wireless frequency band, channel 6 is used as the frequency channel.

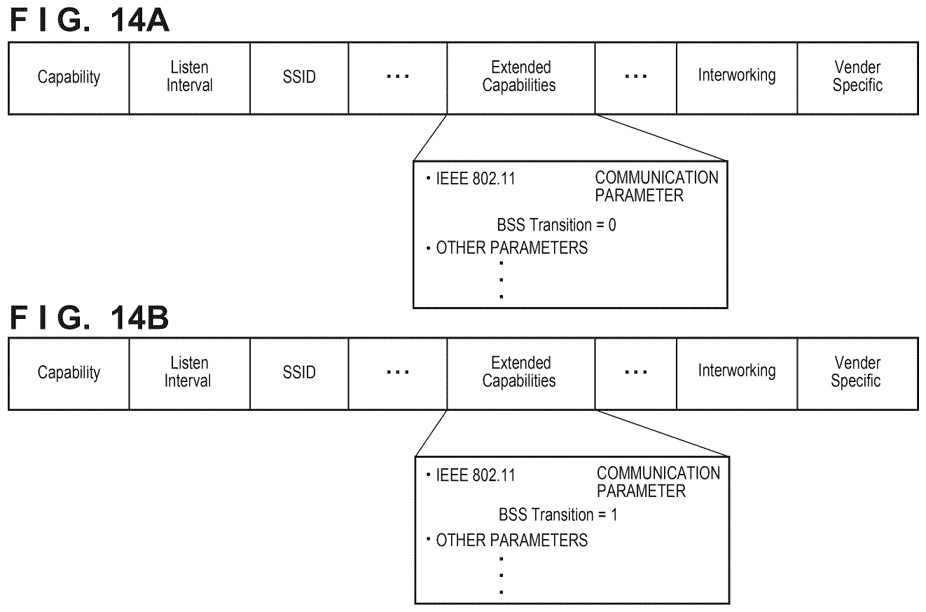

Next, the CPU 212 determines whether or not there is a connection setting with an AP in the wireless infrastructure mode via the setting value relating to the wireless communication operation mode read out in step S701 (step S705). In a case where there is a connection setting with an AP (yes in step S705), the CPU 212, via the processing of steps S706 and S707, causes the AP 101 to recognize that the MFP 100 does not support Agile Multiband. When wireless connection with the STA starts, the AP that supports IEEE 802.11v sets whether or not the STA supports IEEE 802.11v (Agile Multiband) via a notification from the STA and does not change this setting after the wireless connection is established. In the processing of steps S706 and S707, the MFP 100 connects to the AP 101 as an apparatus that does not support Agile Multiband. In step S706, the CPU 212 generates data of an association request frame including information indicating that IEEE 802.11v is not supported as preparation for wireless connection. The association request frame will be described below with reference to FIGS. 14A and 14B. Thereafter, in step S707, the CPU 212 executes processing for wireless connection with the AP 101 using the generated data of the association request frame (step S707). Using the generated data of the association request frame may refer to the CPU 212 transmitting an association request frame to the AP 101, for example. Thus, the AP 101 sets Agile Multiband to disabled for the connection with the MFP 100, and the AP switching processing according to the situation described with reference to FIG. 6 is not executed and the connection with the AP 101 is maintained.

On the other hand, in a case where there is no connection setting with an AP (no in step S705), the CPU 212 ends the processing relating to wireless settings when the power is on without executing the AP connection processing and goes into a standby state.

Also, in a case where it is determined that the “Wireless LAN” setting is enabled and the “Wireless Direct” setting is disabled (no in step S703), operation only occurs in the wireless infrastructure mode. Thus, via the processing of step S708 onward, connection processing with the AP 101 is executed with Agile Multiband in an enabled state. The MFP 100 activated with this condition operates as a STA with Agile Multiband enabled on the basis of the sequence illustrated in FIG. 6. In step S708, the processing for determining whether or not there is AP connection history may be the same as in step S705. Thus, detailed description will be omitted. In a case where it is determined that there is a connection setting with an AP (yes in step S708), in step S709, the CPU 212 generates data of an association request including information indicating that IEEE 802.11v is supported as preparation for wireless connection. Thereafter, in step S709, the CPU 212 executes processing for wireless connection with the AP 101 using the generated data of the association request frame (step S710). Thus, the AP 101 sets Agile Multiband to enabled for the connection with the MFP 100, and the AP switching processing according to the situation is executed as described with reference to FIG. 6.

Lastly, in step S702, in a case where it is determined that the communication setting “Wireless LAN” is in the disabled state, in step S711, the CPU 212 determines whether the WFD mode is enabled. In a case where it is determined that the WFD mode is enabled (yes in step S711), in step S712, the CPU 212 executes activation processing as a WFD master station. The processing of steps S711 and S712 may be similar to the processing of steps S703 and S704.

As described above, according to the present embodiment, in the case of activation with settings for simultaneous operation of the wireless infrastructure mode and the wireless direct (P2P mode, in particular WFD mode), the electronic device such as the MFP 100 notifies that IEEE 802.11v is not supported and connects to the AP. This would cause the AP 101 to recognize that the MFP 100 does not support IEEE 802.11v and cause transmission of a wireless connection destination change request to the MFP 100 not to be performed. In this manner, since a wireless connection change for the MFP 100 is not requested, due to disconnection of the wireless infrastructure connection with the AP 101 by Agile Multiband and processing to reconnect to a different AP, the effects on the wireless direct connection communication can be reduced. According to the present embodiment, such AP switching is prevented, and stable communication operations can be guaranteed even for a wireless direct connection during simultaneous operation. Also, when the AP 101 recognizes that the MFP 100 does not support IEEE 802.11v, transmission to the MFP 100 of a measurement request (the request described in S601) from the AP 101 is prevented. Thus, measurement (AP search) in response to the measurement request of the MFP 100 and responding to the measurement request (processing of S603) can also be suppressed. Accordingly, effects including the processing load and the power consumption being reduced and resources for other processing being freed up can be achieved.

### Second Embodiment

In the first embodiment, Agile Multiband operations are suppressed when the MFP 100 is activated with both the wireless LAN, the MFP 100 communication setting, and the wireless direct settings are in an enabled state. Not just at the time of activation, even in a case where the communication setting is changed while the MFP 100 is operating, and in particular when there is a wireless infrastructure mode connection, Agile Multiband operations can be suppressed according to the settings.

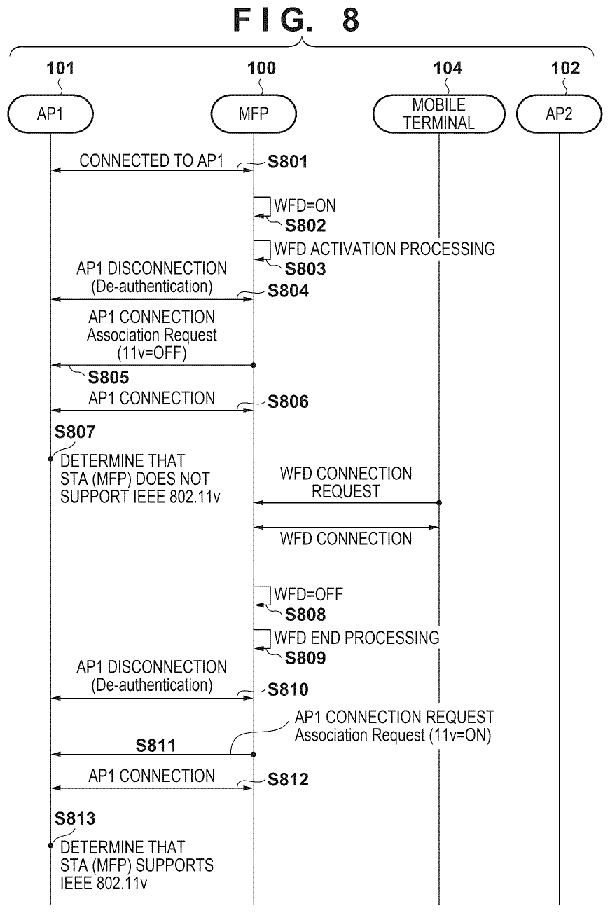

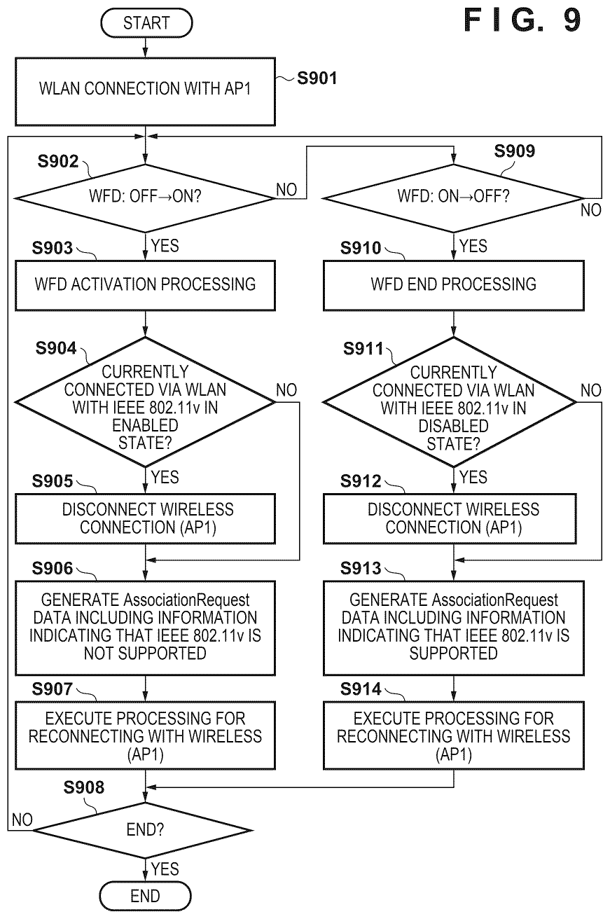

A method for the MFP 100 to suppress Agile Multiband operations when the P2P mode, for example, the wireless direct (WFD mode), is activated while the MFP 100 is connected to the AP 101 via wireless LAN will be described using FIGS. 8 and 9. Note that the processing illustrated in both diagrams may be implemented by the CPU 212 reading out various types of programs stored in a memory such as the ROM 213 provided in the MFP 100 to the RAM 214 and executing the programs.

FIG. 8 is a sequence diagram illustrating processing when the wireless direct (WFD mode) is activated while the MFP 100 is activated and connected to the AP 101 via wireless LAN. The processing starts from a connection state in a case where yes is determined in step S708 of FIG. 7. In other words, in step S801, with Agile Multiband in an enabled state, the MFP 100 is connected to the AP 101 via wireless LAN and wireless direct of the MFP 100 is in a disabled state. Also, in the same diagrams, processing in the case of disabling wireless direct again after wireless direct of the MFP 100 was enabled is illustrated.

First, the operation display unit 220 of the MFP 100 accepts a user operation, and wireless direct, which is a communication settings menu item illustrated in FIG. 3C, is set to an enabled state (step S802). According to the setting, the CPU 212 activates the WFD mode (step S803). The WFD mode activation processing is similar to that of step S704 of FIG. 7. Then, the processing of step S804 onward causes the AP 101 to recognize that the MFP 100 does not support Agile Multiband. When wireless connection with the STA starts, the AP that supports IEEE 802.11v sets whether or not the STA supports IEEE 802.11v (Agile Multiband) via a notification from the STA and does not change this setting after the wireless connection is established. In the processing of steps S804 to S806, the wireless connection with the AP 101 is temporarily disconnected from the MFP 100, and then the MFP 100 reconnects to the AP 101 as an apparatus that does not support Agile Multiband. In this manner, the AP 101 recognizes the MFP 100 as a STA that does not support Agile Multiband, and Agile Multiband in the MFP 100 is disabled. First, in step S804, the CPU 212 disconnects the wireless connection with the AP 101. For example, the connection is disconnected by transmitting a de-authentication frame. Next, in step S805, the CPU 212 transmits, to the AP 101, a connection request using an association request including information indicating that IEEE 802.11v is not supported. At this time, that IEEE 802.11v is not supported is communicated. Thus, the AP 101 and the MFP 100 are reconnected (step S806). The details are as in steps S706 and S707 of FIG. 7.

As described above, according to the present embodiment, in a state where wireless direct is disabled and then the wireless direct (WFD mode) is activated while the MFP 100 is connected to the AP in the wireless infrastructure mode, the MFP 100 temporarily disconnects the wireless communication with the AP 101. Then, the MFP 100 notifies the AP 101 that IEEE 802.11v is not supported and reconnects with the AP 101. This would cause the AP 101 to recognize that the MFP 100 does not support IEEE 802.11v and cause transmission of a wireless connection destination change request to the MFP 100 not to be performed (step S807). In this state, the MFP 100 executes, in parallel with wireless infrastructure communication, processing including communicating with the mobile terminal apparatus 104 as a WFD master unit, printing, and the like. Thus, even in a case where the communication settings are dynamically changed while the MFP 100 is activated, if there is simultaneous operation, the wireless connection between the MFP 100 and the AP 101 is not disconnected, and a stable printing operation is guaranteed.

Next, in step S808 onward, a process is illustrated in which, when the wireless direct setting is changed from enabled to disabled, the MFP 100 and the AP 101 reconnect with Agile Multiband being enabled again. The operation display unit 220 of the MFP 100 accepts a user operation, and wireless direct, which is a communication settings menu item illustrated in FIG. 3C, is set to a disabled state (step S808). According to the setting, the CPU 212 ends the WFD mode (step S809). After the CPU 212 stops operating as a WFD mode master station in step S809, the connection with the currently connected AP 101 is temporarily disconnected (step S810). Then, the CPU 212 executes processing to reconnect to the AP 101 with Agile Multiband in an enabled state (step S811). In this manner, connection with the AP 101 is resumed (step S812). The processing of step S811 onward may be similar to that of steps S709 to S710 of FIG. 7 and thus will not be described in detail. Thus, similar to after activation via step S710 of FIG. 7, in a case where the MFP 100 operates in a state where the WFD mode is disabled and only wireless LAN is enabled, Agile Multiband is enabled (step S813).

FIG. 9 is a diagram illustrating a flowchart of a processing process executed by the MFP 100 illustrated in the sequence diagram of FIG. 8, and as in FIG. 8, the processing process illustrated is of a case where wireless direct is enabled while the MFP 100 is connected to the AP 101 via wireless LAN. Note that the processing illustrated in the flowchart of FIG. 9 may be implemented by the CPU 212 reading out various types of programs stored in a memory such as the ROM 213 provided in the MFP 100 to the RAM 214 and executing the programs.

First, at the start of the processing of FIG. 9, the activation state corresponds to that of after activation processing is executed after yes has been determined in step S708 of FIG. 7, and the MFP 100 has established a wireless connection with the AP 101 in the wireless infrastructure mode. At this time, Agile Multiband is in an enabled state, and wireless direct is in a disabled state (step S901).

Then, the CPU 212 waits for a setting change instruction on the operation display unit 220 via a user operation and searches for whether or not there has been a change to the wireless direct (WFD) setting. Specifically, in step S902, the CPU 212 tests whether the wireless direct (WFD) setting has been changed from off to on, that is, from a disabled state or an enabled state. If this is not the case, in step S909, the CPU 212 tests whether the wireless direct (WFD) setting has been changed from on to off, that is, from an enabled state to a disabled state. If it is determined that wireless direct (WFD) has been changed from disabled to enabled (yes in step S902), in steps S903 onward, the CPU 212 activates the WFD mode and temporarily disconnects the wireless infrastructure with the AP 101. Thereafter, the CPU 212 executes processing to reconnect with the AP 101 with Agile Multiband set to disabled. The processing executed in these steps corresponds to the processing executed by the CPU 212 in steps S803 to S806 of FIG. 8. The details are as follows.

In step S903, the CPU 212 activates the WFD mode. Then, in step S904, the CPU 212 determines whether it is currently connected to the AP 101 via WLAN with IEEE 802.11v in an enabled state. In other words, it is determined whether Agile Multiband is enabled via the WLAN connection with the AP 101. This determination, for example, may be performed on the basis of the IEEE 802.11v enabled/disabled (supported/no supported) stored at the time of connection in association with the SSID. Note that as described below, step S904 may not be performed, and in this case, in particular, the IEEE 802.11v enabled/disabled may not be stored.

In step S904, in a case where it is determined that the CPU 212 is connected to the AP 101 with IEEE 802.11v in an enabled state, in step S905, the CPU 212 disconnects the WLAN connection with the AP 101. Thereafter, in step S906, the CPU 212 generates association request data including information indicating that IEEE 802.11v is not supported. This is transmitted to the connection destination AP (AP 101) disconnected in step S905, and reconnection processing is executed (step S907).

Note that in a case where the CPU 212 determines that the connection with the AP 101 has been temporarily disconnected via processing in step S904 (no in step S904), the processing proceeds to the step S906 onward without the WLAN disconnection processing of step S905 being executed.

Lastly, in a case where the CPU 212 determines whether or not a predetermined end condition such as transition to a power saving mode or the pressing of a power button has been established and determines that it is not established (no in step S908), the processing returns to step S902 to wait for a user operation again. In other words, the processing illustrated in FIG. 9 may be repeatedly executed while the MFP 100 is operating.

On the other hand, in step S902, in a case where the wireless direct (WFD) setting has not been changed from disabled to enabled (no in step S902), the CPU 212 searches for whether or not WFD has been changed from enabled to disabled (step S909). In a case where it is determined that WFD has been changed from enabled to disabled, in step S910, the CPU 212 ends WFD. Then, in step S911, the CPU 212 determines whether it is currently connected to the AP 101 via WLAN with IEEE 802.11v in a disabled state. In other words, it is determined whether Agile Multiband is disabled via the WLAN connection with the AP 101. This determination, for example, may be performed on the basis of the IEEE 802.11v enabled/disabled (supported/no supported) stored at the time of connection in association with the SSID. Note that as described below, step S911 may not be performed, and in this case, in particular, the IEEE 802.11v enabled/disabled may not be stored.

In step S911, in a case where it is determined that the CPU 212 is connected to the AP 101 with IEEE 802.11v in a disabled state, in step S912, the CPU 212 disconnects the WLAN connection with the AP 101. Thereafter, in step S913, the CPU 212 generates association request data including information indicating that IEEE 802.11v is supported (step S913). This is transmitted to the connection destination AP (AP 101) disconnected in step S912, and reconnection processing is executed (step S914).

In this manner, in step S910 onward, the CPU 212 ends the WFD mode, and after temporarily disconnecting (also referred to as ending or cancelling) the wireless infrastructure mode connection with the AP 101, processing to reconnect to the AP 101 is executed with Agile Multiband set to enabled. The processing executed in these steps corresponds to the processing executed by the CPU 212 in steps S808 to S812 of FIG. 8.

As described above, according to the present embodiment, even with a configuration in which wireless direct operation settings can be dynamically changed while an electronic device such as an MFP is connected to an AP in the wireless infrastructure mode, only during simultaneous operation can the wireless infrastructure mode Agile Multiband be disabled. Accordingly, AP switching due to Agile Multiband is prevented, and stable communication operations are guaranteed even for a wireless direct connection during simultaneous operation. Also, when a slave station electronic device is recognized as not supporting IEEE 802.11v by an AP, transmission to the slave station electronic device of a measurement request from the AP is prevented. Thus, measurement (AP search) in response to the measurement request of the slave station electronic device and responding to the measurement request can also be suppressed. Accordingly, effects including the processing load and the power consumption being reduced and resources for other processing being freed up can be achieved.

Note that for non-existing connections, as long as disconnection processing does not produce, in particular, an error or the like, steps S904 and S911 of FIG. 9 may not be performed. In this case, each step is connected to the steps before and after it. Also, in a case where the determination result of steps S904 and S911 is no, they may both branch to step S908. By doing so, in a case where the determination result of steps S904 and S911 is no, the connection with the AP at this time is maintained.

### Third Embodiment

In the second embodiment, the method for disabling connection destination switching due to Agile Multiband includes, during simultaneous operation of the wireless infrastructure mode and the wireless direct (WFD) mode, reconnecting after temporarily disconnecting the wireless infrastructure mode connection. Regarding this, in the present embodiment, the AP 101 stays connected in a state having recognized the MFP 100 as a STA that supports Agile Multiband and changes the method of responding to the frame specified in the IEEE 802.11v standard. In this manner, the connection destination switch request is disabled.

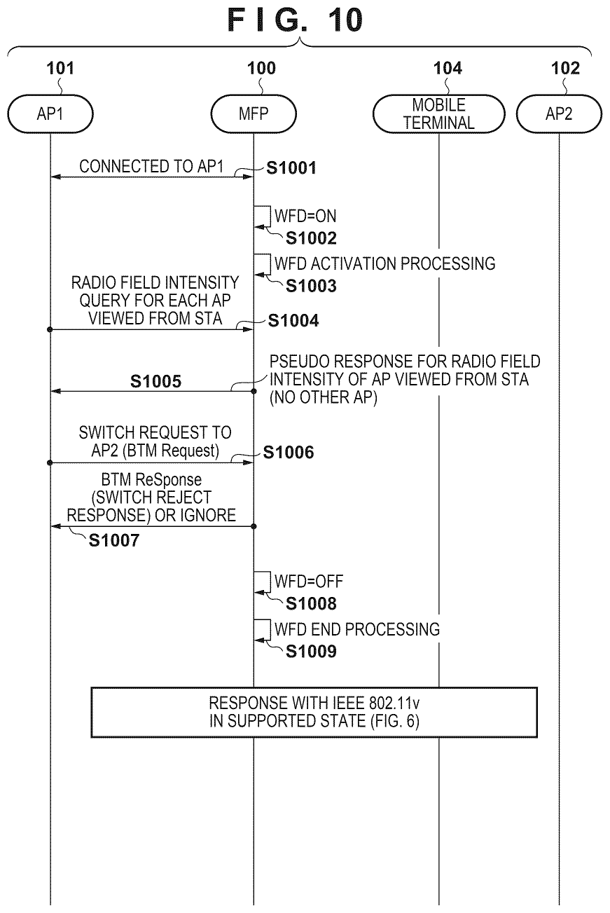

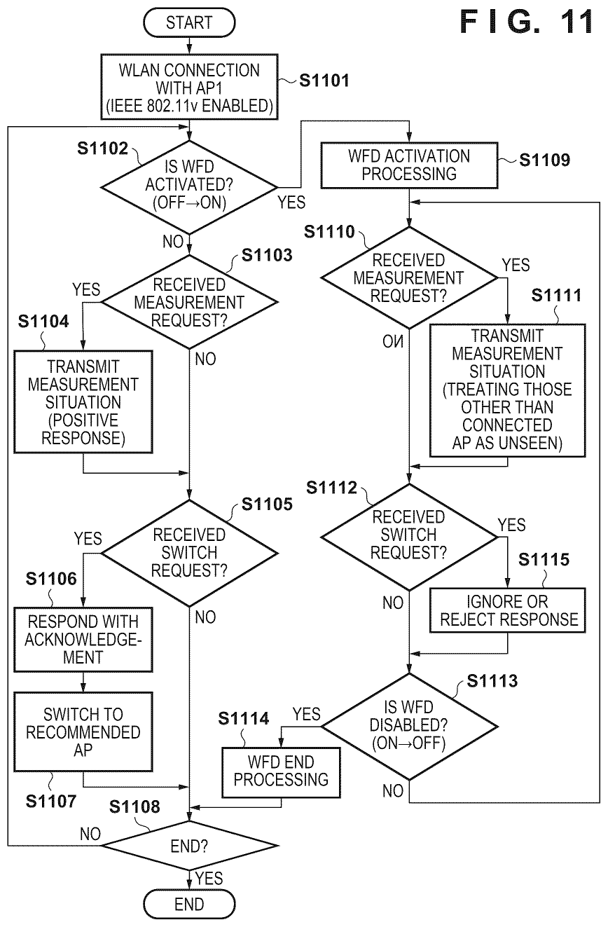

Control of the MFP 100 according to the present embodiment relating to a connection destination change request from the AP 101 will be described below using the sequence diagram of FIG. 10 and the flowchart of FIG. 11. Note that the processing illustrated in both diagrams may be implemented by the CPU 212 reading out various types of programs stored in a memory such as the ROM 213 provided in the MFP 100 to the RAM 214 and executing the programs.

FIG. 10 is a sequence diagram of an operation to not accept or to reject after accepting a connection destination change request from the AP 101 when the wireless direct setting is enabled while the MFP 100 according to the present embodiment is connected to the AP 101 via wireless LAN.

In the initial state of FIG. 10, the MFP 100 has established a connection with the AP 101 in the wireless infrastructure mode, and the AP 101 has determined that the MFP 100 supports IEEE 802.11v (step S1001). This state is similar to that of step S601 of FIG. 6 and step S801 of FIG. 8. Also, when the CPU 212 of MFP 100 detects that the wireless direct (WFD) setting has become the enabled state via the operation display unit 220, as in steps S802 and S803 of FIG. 8 (step S1002), the WFD mode is activated (step S1003).

Next, in step S1004, when the CPU 212 receives a measurement request (corresponding to step S601 of FIG. 6) from the AP 101, the CPU 212 responds to the measurement request with a beacon report with content indicating that no APs exist other than the currently connected AP 101 (step S1005). Specifically, a beacon report not including a signal quality measurement result relating to an AP other than the currently connected AP 101 is transmitted to the AP 101. Alternatively, in step S1005, a beacon report not including information of a signal quality measurement result from the currently connected AP 101 and another AP may be generated and transmitted to the AP 101. In other words, the response transmitted in step S1005 in this case includes content not including information relating to another AP regardless of the signal quality measurable in the case of an actual AP search being performed relating to other APs. This corresponds to content indicating that an AP search would not find another AP. In other words, this corresponds to content indicating that at least a part of the signal quality from another AP is worse than in a case where an AP search is actually performed. Alternatively, this corresponds to content indicating that an access point with a better communication state than that of the currently connected access point does not exist in regard to the radio field intensity measurement request received from the AP. Hereinafter, a response to the measurement request different from the result of an actual AP search may also be referred to as a pseudo response. Note that signal quality can be referred to as the communication state, and good signal quality can be referred to as a good communication state.

As in step S1005, by performing a pseudo response of a beacon report not including a signal quality measurement result from an AP other than the currently connected AP 101, the AP 101 can recognize that if connection is disconnected, there are no other APs that can connect. Thus, it can be expected that a connection destination change request transmitted from the AP 101 is strongly suppressed and that a forcible disconnection of the connection from the AP 101 is suppressed.

On the other hand, even before sending a pseudo response to the measurement request from the AP 1 or even if a pseudo response has been sent, in some cases, the AP 101 may transmit a connection destination change request (also referred to as a BTM request or a switch request) to the MFP 100 (step S1006). This is a request corresponding to step S605 of FIG. 6. Also, in the present embodiment, in a case where the CPU 212 receives a connection destination change request (BTM request) from the AP 101, in step S1007, the CPU 212 sends a reject response to the connection destination change request or ignores the connection destination change request (does not send a response to the connection destination change request).

Lastly, if it is detected that the wireless direct (WFD) setting is changed from enabled to disabled (step S1008), the CPU 212 ends the operations as a WFD mode master station (step S1009). In other words, the WFD mode is ended. Thereafter, by performing similar operations to that of the processing illustrated in step S601 and onward of FIG. 6, a response to the connection destination switch request corresponding to Agile Multiband is performed.

In this manner, in a situation where the wireless infrastructure mode and the wireless direct (WFD) mode are operating simultaneously, a connection destination change based on a connection destination change request can be suppressed from being performed.

FIG. 11 is a flowchart of an operation to not accept or to reject after accepting a connection destination change request from the AP 101 when the wireless direct is enabled while the MFP 100 according to the present embodiment is connected to the AP 101 via wireless LAN. The processing of this flowchart is implemented by the CPU 212 of the MFP 100 loading a program stored in the storage medium onto the RAM and executing the program or by the CPU 212 executing a program stored in the ROM. First, at the start of the processing of FIG. 11, as in step S901 of FIG. 9, the MFP 100 has established a wireless connection with the AP 101 in the wireless infrastructure mode (S1101). This corresponds to an activated state after yes is determined in step S708 of FIG. 7, and the Agile Multiband setting is in an enabled state and the wireless direct (WFD) setting is in a disabled state.

Next, in step S1102, as in step S902 of FIG. 9, the CPU 212 searches for whether or not the wireless direct (WFD) setting has changed from disabled to enabled. In a case where it is determined that the wireless direct (WFD) setting has been changed from disabled to enabled (yes in step S1102), in step S1109, the CPU 212 activates the WFD mode (this corresponds to step S903).

In FIG. 9 of the second embodiment, after the WFD mode is activated, the wireless infrastructure mode connection with the AP 101 is temporarily disconnected. However, in the present embodiment, Agile Multiband remains enabled, and the response of step S1110 onward is performed.

In step S1110, the CPU 212 determines whether or not a measurement request (corresponding to step S601 of FIG. 6) has been received from the AP 101.

Here, the measurement request corresponds to the measurement request received from the AP 101 in step S1004 of FIG. 10. If the CPU 212 receives a measurement request from the AP 101 (yes in step S1110), the pseudo response illustrated in step S1005 is transmitted (step S1111). In step S1111, a measurement result of the radio intensity from the AP 101 is transmitted as a response as if no APs exist other than the currently connected AP 101.

Next, in step S1112, the CPU 212 determines whether or not a connection destination change request (BTM request) has been received from the AP 101. Here, the connection destination change request corresponds to a switch request received from the AP 101 in step S1006 of FIG. 10. In a case where the CPU 212 has received a connection destination change request (yes in step S1112), the CPU 212 sends a reject response to the connection destination change request or ignores the connection destination change request (step S1115, corresponds to step S1007 in FIG. 10). In the present embodiment, it is sufficient that the connection destination is not switched due to Agile Multiband during simultaneous operation. Thus, the response to the connection destination change request may be either an ignore response or a reject response. However, in a case where a change reject response is transmitted to the connection destination change request in step S1115, there is a possibility that from then on, the AP 101 does not transmit another measurement request or a connection destination change request to the MFP 100 that responded once with a reject response. Thus, even after disabling the wireless direct setting after it being enabled, a measurement request and a connection destination change request are not transmitted from the AP and Agile Multiband operations remain as disabled. Accordingly, in a case where in step S1115, the connection destination change request is responded to with a change rejection and the wireless direct setting is thereafter disabled, as illustrated in FIG. 9 of the second embodiment, the wireless direct (WFD) mode is ended and disabled. Thereafter, the wireless infrastructure mode connection may be temporarily disconnected and reconnected. At this time, information indicating that Agile Multiband is enabled may be transmitted to the AP to be reconnected, and Agile Multiband may be enabled to function.

Thereafter, in step S1113, as in step S909 of FIG. 9, the CPU 212 searches for whether or not the wireless direct (WFD) setting has been changed from enabled to disabled. Then, in a case where it is determined that the WFD setting has not changed (no in step S1113), the CPU 212 returns to processing to step S1110. Thus, pseudo responses continue to be sent in response to the measurement requests and ignore or reject responses continue to be sent in response to the switch requests. On the other hand, in a case where it is determined that the wireless direct (WFD) setting has been changed from disabled to enabled (yes in step S1113), in step S1114, the CPU 212 ends the WFD mode (corresponding to step S910) and proceeds the processing to step S1108. In step S1108, as in step S908 of FIG. 9, the CPU 212 determines whether or not an end condition such as transition to a power saving mode or the pressing of a power button has been satisfied. In a case where the end condition is not satisfied (no in step S1108), the MFP 100 returns to the processing to step S1102, and a response corresponding to Agile Multiband is performed with only the wireless infrastructure mode in an operating state. In a case where the end condition is satisfied (yes in step S1108), the flowchart illustrated in FIG. 11 ends.

Hereinafter, a response to a measurement request and a switch request in a case where it is determined in step S1102 that the wireless direct (WFD) setting has not changed will be described.

In step S1103, the CPU 212 determines whether or not a measurement request has been received from the AP 101. Then, if a measurement request has been received, the operating state is the wireless infrastructure mode only. Thus, in step S1104, the CPU 212 searches for surrounding APs or uses information from a completed search to generate a measurement result and transmits this to the AP 101. This processing corresponds to the processing of step S603 of FIG. 6. In this manner, in a case where the wireless infrastructure mode and the wireless direct (WFD) mode are not operating simultaneously (a state where no is determined in step S1102), a response (positive response) to the measurement request includes the content of an actual measurement (content of a measurement result).

In step S1105, the CPU 212 determines whether or not a connection destination change request (switch request) has been received. In a case where it has been received, the processing proceeds to step S1106. In a case where it has not been received, the processing proceeds to step S1108. In step S1106, the CPU 212 responds by acknowledging the connection destination change request. In step S1107, the CPU 212 transmits a connection request to the AP designated in the connection destination change request and switches connection. The processing of steps S1106 to S1107 corresponds to the processing of steps S606 to S608 of FIG. 6 described above. Lastly, in step S1108, the CPU 212 determines whether the end condition is satisfied. If it is not satisfied, the processing is executed from step S1102. If it is satisfied, the processing ends.

As described above, according to the present embodiment, in a situation in which the wireless infrastructure mode and the wireless direct mode are operating simultaneously, a pseudo response to the measurement request received from the currently connected AP is sent with content indicating the situation is worse than the situation actually measured regarding the surrounding APs. This can suppress transmission of a connection destination change request for requesting to change the connection destination from the currently connected AP to another AP. In other words, this can prevent a change to an inappropriate connection destination AP, allowing communication processing during simultaneous operation to be stable and appropriately executed.

Also, the MFP ignores or rejects the connection destination change request from the AP. In this manner, even if an AP connection destination change request is transmitted, a change of the connection destination AP in a state with the WFD mode activated, that is, in an enabled state, can be prevented, allowing communication processing via the WFD mode during simultaneous operation to be stable and appropriately executed.

### Modified Example of Third Embodiment

In FIG. 11, in response to the wireless direct (WFD) setting being enabled, measurement requests and connection destination change requests from APs are accommodated via the loop of steps S1110 to S1113 as long as the wireless direct (WFD) setting is not disabled. However, measurement requests and connection destination change requests from APs may be accommodated in a non-synchronous manner with an operation to enable or disable the wireless direct (WFD) setting.

Thus, for example, the CPU 212 of the MFP 100 that has received a message from an AP determines whether the message is a measurement request. If it is a measurement request, the CPU 212 determines whether the WFD mode is currently enabled or disabled. This determination may be performed on the basis of the wireless direct setting as in the settings of FIG. 3C, and whether the WFD mode is enabled or disabled may be determined by referencing this setting. If the WFD mode is enabled, the CPU 212 executes the processing of step S1111. If the WFD mode is disabled, the CPU 212 executes the processing of step S1104.

In a case where the message received from an AP is not a measurement request, it is determined whether the message is a connection destination change request. If it is a connection destination change request, it is determined whether the WFD mode is currently enabled or disabled. If the WFD mode is enabled, the CPU 212 executes the processing of step S1115. If the WFD mode is disabled, the CPU 212 executes the processing of steps S1106 to S1107.

In a case where the received message is neither a measurement request nor a connection destination change request, the CPU 212 may execute processing in accordance with the message.

In an example where the present modified example is applied to FIG. 10, in step S1004, the MFP 100 receives a radio field intensity query from the AP 1. If the wireless direct (WFD) setting is enabled at this time, in step S1005, a beacon report not including a signal quality measurement result of an AP other than the currently connected AP 101 is transmitted to the AP 101. Alternatively, in step S1005, a beacon report not including information of a signal quality measurement result from any AP may be generated and transmitted to the AP 101 by the MFP 100. Also, in step S1008, if the WFD mode is activated when a connection destination change request is received from the AP 101, in step S1009, the MFP 100 sends a reject response to the connection destination change request or ignores the connection destination change request.

Also, in the present modified example, when the wireless direct (WFD) setting is operated to be disabled, in addition to the WFD mode being ended, the connection with the AP currently connected to via wireless infrastructure communication may be temporarily disconnected and then reconnected. Regarding reconnection, by transferring information indicating that the MFP 100 supports Agile Multiband to an AP via a connection request or the like, the operation in accordance with Agile Multiband between the MFP 100 and the AP can be resumed.

Via such processing, an effect similar to that of the third embodiment is achieved. Note that in the present modified example, an operation to enable or disable the wireless direct (WFD) setting between a measurement request and a connection destination change request may be performed, and depending on this, the WFD mode may be activated or ended. However, regarding each message, whether the wireless direct (WFD) setting is enabled at the time of reception is determined, and a response in accordance with this determination result is sent. Thus, if the WFD mode is activated, operations in accordance with Agile Multiband can be suppressed.

### Fourth Embodiment

In the second and third embodiment, control when enabling the wireless direct (WFD) setting and performing simultaneous operation while the MFP 100 and the AP 101 are connected in the wireless infrastructure mode was described. The present disclosure can also be applied to the case of changing the wireless infrastructure mode setting. In the MFP 100 according to the present embodiment, when the wireless infrastructure mode is enabled from a control panel, if the MFP 100 is operating as a wireless direct mode (WFD mode) master station, Agile Multiband is disabled. In this manner, disregarding the order of enabling each mode, if the wireless direct mode is in an enabled state, processing in accordance with Agile Multiband can be suppressed.

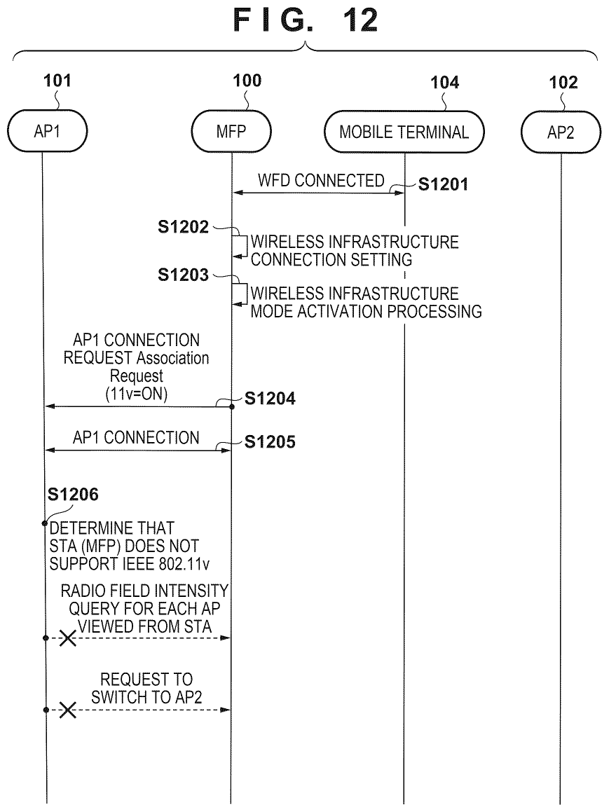

FIG. 12 is a sequence diagram illustrating the processing in the case of performing a setting to connect to the AP 101 in the wireless infrastructure mode while the MFP 100 is activated and operating in the wireless direct mode. The processing starts from an activation state in a case where yes is determined in step S711 of FIG. 7. In other words, in step S1201, the MFP 100 is operating as a WFD mode master station, and the wireless infrastructure mode is in a disabled state.

In the present embodiment, the processing illustrated in FIG. 12 may be implemented by the CPU 212 reading out various types of programs stored in a memory such as the ROM 213 provided in the MFP 100 to the RAM 214 and executing the programs.

First, when the operation display unit 220 accepts a user operation and the wireless infrastructure setting, which is a communication settings menu item illustrated in FIG. 3C, is set to an enabled state (step S1202), the CPU 212 activates the wireless infrastructure mode (step S1203). In the wireless infrastructure mode activation processing, initialization processing of the wireless unit 226 including setting the communication channel and the like is executed. Also, the MFP 100 causes the AP 101 to recognize that the MFP 100 does not support Agile Multiband. Thus, in the present embodiment, the CPU 212 transmits a connection request to the AP 101 with the MFP 100 as an apparatus not supporting Agile Multiband (step S1204) and establishes a connection with the AP (step S1205). Accordingly, the AP 101 recognizes the MFP 100 as a STA that does not support Agile Multiband (step S1206), and measurement requests and connection destination switch requests for the MFP 100 are suppressed.

Accordingly, a radio field intensity query (measurement request) illustrated in FIG. 12 (step S1207) and a connection destination change request (switch request) (step S1208) are not transmitted from the AP 1 (101) to the MFP 100. Thus, even in a case where connection via wireless infrastructure communication is set during a WFD connection, processing in conjunction with an AP switch for Agile Multiband is suppressed, and WFD mode communication is not hindered.

### Fifth Embodiment

In the MFP 100 according to the fourth embodiment, when the wireless infrastructure setting is enabled from the control panel, if the MFP 100 is operating as a wireless direct (WFD) master station, the MFP 100 connects to the AP not supporting IEEE 802.11v. By applying a method similar to that of the third embodiment while keeping support for IEEE 802.11v depending on the specification of the MFP 100, processing for Agile Multiband can also be suppressed.

By the MFP 100 according to the present embodiment sending a pseudo response to the measurement request or switch request while connected to an AP as a STA that supports IEEE 802.11v, the MFP 100 causes the AP to recognize the MFP 100 as a STA that does not support Agile Multiband.

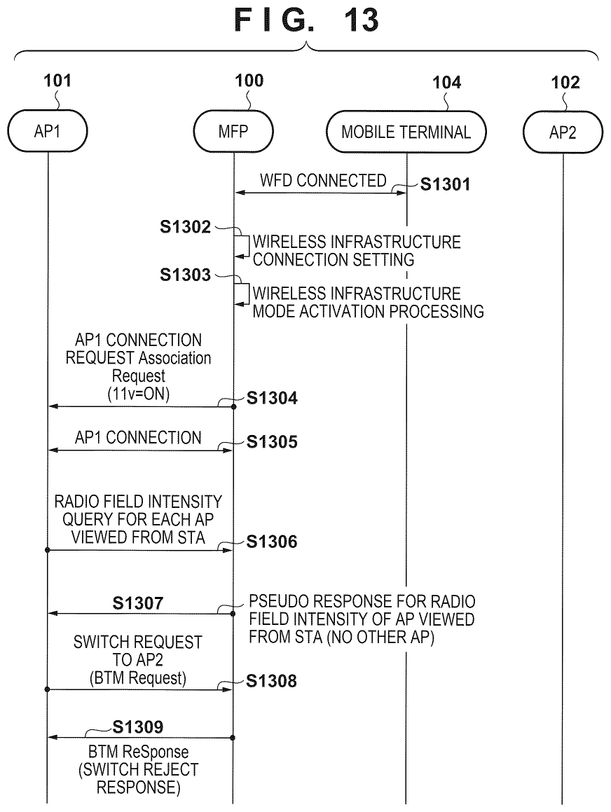

FIG. 13 is a sequence diagram illustrating the processing in the case of performing a setting to connect to the AP 101 in the wireless infrastructure mode while the MFP 100 is activated and wireless direct is operating. The processing starts from an activation state in a case where yes is determined in step S711 of FIG. 7. In other words, in step S1201, the MFP 100 is operating as a WFD mode master station, and the wireless infrastructure mode is in a disabled state.

In the present embodiment, the processing illustrated in FIG. 13 may be implemented by the CPU 212 reading out various types of programs stored in a memory such as the ROM 213 provided in the MFP 100 to the RAM 214 and executing the programs.

The processing of steps S1302 and S1303 is the same as the processing of steps S1202 and S1203 of FIG. 12. By the wireless infrastructure mode of the communication settings being enabled (step S1302), the CPU 212 activates the wireless infrastructure mode (step S1303). Then, in step S1304, the MFP 100 transmits a connection request to the AP using an association request frame indicating that the MFP 100 supports IEEE 802.11v and, in step S1305, connects to the AP. This is the same as the processing of steps S709 to S710 of FIG. 7.

Next, while the WFD mode is activated (or enabled), the CPU 212 sends a pseudo response to the measurement request or switch request from the AP specified in IEEE 802.11v. Specifically, when the CPU 212 receives a radio field intensity query (measurement request) from the AP in step S1306, in step S1307, the CPU 212 transmits a pseudo response to the AP. Also, when the CPU 212 receives a connection destination change request (switch request) from the AP in step S1308, in step S1309, the CPU 212 transmits a switch reject response to the AP or ignores the switch request. In this manner, the connection destination switch is nullified. This processing may be similar to the processing of steps S1004 to S1007 of FIG. 10.

Also, while the WFD mode is enabled, an appropriate response is sent back in response to the measurement request or the switch request from the AP, and an AP switch is allowed. In a case where a reject response is sent back in response to a switch request while the WFD mode is enabled, when the WFD mode is disabled, the connection with the AP which returned a reject response may be reconnected. At this time, information indicating support for IEEE 802.11v may be transmitted to the AP, and a connection request may be sent.

As described above, in a case where the wireless infrastructure is enabled and the MFP 100 connects to the AP 101 while the MFP 100 is operating as a wireless direct master station, a pseudo response is sent in response to the measurement request and the connection destination switch request for the MFP 100. Via this processing, the AP can be caused to recognize the MFP 100 as a STA that does not support Agile Multiband. Accordingly, AP switching is prevented, and stable communication operations can be guaranteed even for a wireless direct connection during simultaneous operation.

### Configuration Example of Association Request Frame Data

FIGS. 14A and 14B illustrate examples of a body portion of association request frame data generated and transmitted at the time of wireless connection with an AP according to each embodiment. The value of BSS Transition included in Extended Capability is set depending on whether or not IEEE 802.11v is supported. Also, in addition to this parameter, the present frame data includes various parameters for starting wireless communication. FIG. 14A is an example of association request frame data in a case where IEEE 802.11v is not supported. The data includes, as the IEEE 802.11 communication parameter, a BSS Transition value of 0. This represents that IEEE 802.11v is not supported. FIG. 14B is an example of association request frame data in a case where IEEE 802.11v is supported. The data includes, as the IEEE 802.11 communication parameter, a BSS Transition value of 1. This represents that IEEE 802.11v is supported.

The configuration examples of the association request frame data illustrated in FIGS. 14A and 14B may be used not only in the first to fifth embodiments described above, but also in the sixth embodiment described below when connecting to an AP in wireless infrastructure mode.

### Sixth Embodiment

In the configuration described in the first to fifth embodiments, a condition to disable Agile Multiband includes wireless communication via a P2P (WLAN) mode (WFD or wireless direct) being enabled while being simultaneously connected to an AP in wireless infrastructure mode. However, in the present embodiment, a case will be described in which the second communication interface (IF) that operates simultaneously with the wireless infrastructure mode, which is the first communication interface provided in the MFP 100, is not limited to being wireless communication via P2P (WLAN).

For example, the present disclosure can be applied to a case where, when the MFP 100 connects to an external apparatus via a wired IF such as universal serial bus (USB) or the like as the second communication IF, AP switching via wireless infrastructure is suppressed and communication via the USB connection is prioritized. In a state where the MFP 100 and an external apparatus are connected via a wired connection, it is expected that the user operates the MFP 100 and the external apparatus (a PC or the like) and there executes a print output or scan job or the like. Thus, AP switching via wireless infrastructure can be suppressed. According to the present embodiment, even in a case where the second communication IF is via a wired connection such as USB, AP switching is prevented, and stable communication operations can be guaranteed even for a USB connection during simultaneous operation.

In particular, in a case where the MFP 100 is provided with a mobile printer function that is operable by being powered by a battery, to reduce power consumption of the battery power source, Agile Multiband processing is preferably disabled to reduce the processing load and the power consumption.

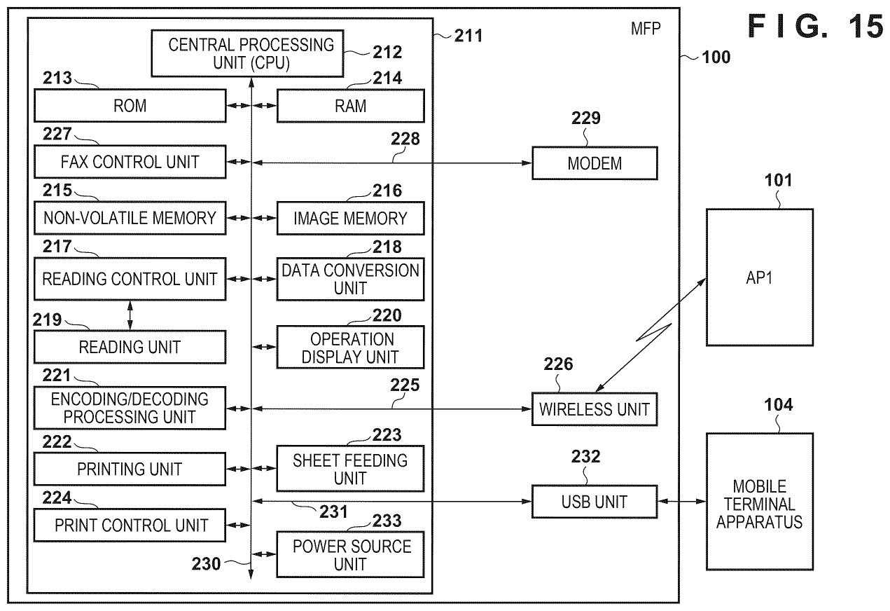

FIG. 15 illustrates a configuration example of the MFP 100 according to the present embodiment. Configurations that may be the same as those in FIGS. 2A and 2B are given the same numbers, and description thereof is omitted. One difference with the configuration illustrated in FIGS. 2A and 2B is that the MFP 100 according to the present embodiment includes a USB unit 232 connected via a dedicated bus 231. The USB unit 232 is a USB device/controller that controls the transmitting and receiving of data with an external apparatus connected via a cable on the basis of the USB standard and is typically configured as apiece of hardware. Also, the CPU 212 controls the transmitting and receiving of data with an external apparatus by the USB unit 232 detecting hardware interrupts.

The MFP 100 according to the present embodiment can simultaneously execute the processing of wireless LAN communication via the AP 101 by the wireless unit 226 and USB communication via the USB unit 232. Note that the external apparatus is illustrated as the mobile terminal apparatus 104 in FIG. 15. However, the external apparatus is not limited to this, and it is sufficient that the external apparatus is a device that functions as a host in accordance with a protocol specified in the USB standard. Other examples include a PC, a tablet terminal, and the like.

Also, the MFP 100 according to the present embodiment includes a power source unit 233 for powering via battery in addition to a power unit (not illustrated) that can connect to an external power source via an electrical outlet. The power source unit 233 includes a removable rechargeable battery and can supply power to an apparatus via the rechargeable battery if the power unit is not connected to an electrical outlet. In other words, the MFP 100 is a printing apparatus with portability as a mobile printer.

The power source states include, for example, a battery dead state in which the battery has no remaining amount, a power-off state in which the power key is not pressed, an activated state of normal operation via an external power source, a power saving standby state, a power supply state of operating while being supplied with power from the rechargeable battery, and a charging state of being charged. Note that in the case of a mobile printer, due to hardware restrictions of the power source unit 233, the activated state and the charging state are mutually exclusive, and the charging state is a form of a power-off state. Accordingly, when operating via battery power via the power source unit 233, the power consumption is preferably reduced as much as possible.

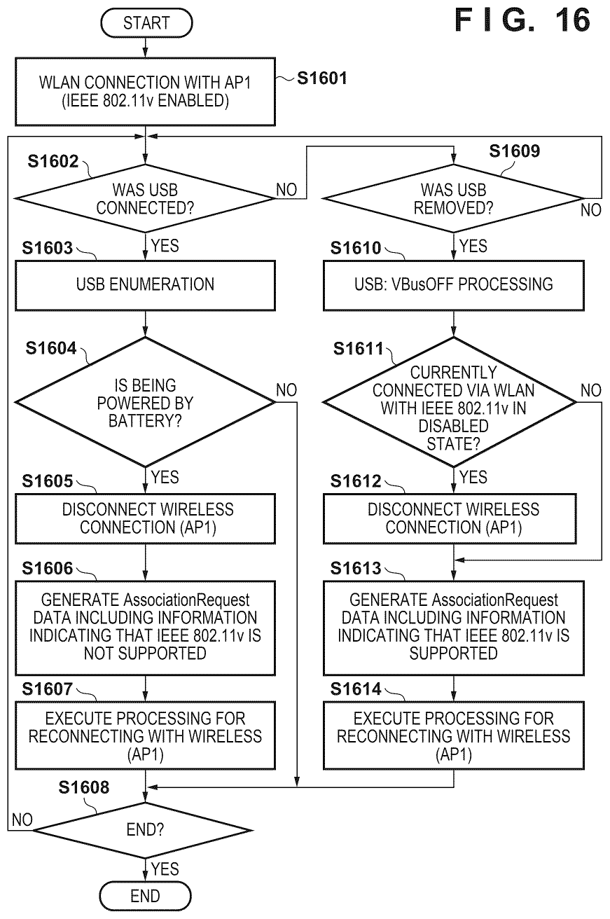

FIG. 16 illustrates the processing process in a case where the MFP 100 is inserted with a USB cable and connected to the mobile terminal 104 while being connected to the AP 101 via wireless LAN or a case where a USB cable is removed and communication with the mobile terminal 104 is disconnected. Note that the processing illustrated in FIG. 16 may be implemented by the CPU 212 reading out various types of programs stored in a memory such as the ROM 213 provided in the MFP 100 to the RAM 214 and executing the programs.

First, at the start of the processing of FIG. 16, the MFP 100 has established a wireless connection with the AP 101 in the wireless infrastructure mode. Connection destination switch operation via Agile Multiband is in an enabled state (step S1601).

In step S1602, the CPU 212 searches for whether or not a USB cable has been connected via a user operation. In a typical USB device, when the USB unit 232 detects the voltage of a VBUS line generated by the USB cable connection as an electrical signal, a VBUS ON interrupt is generated, and the CPU 212 detects the interrupt and determines that the USB cable is connected. When the USB cable is connected (yes in step S1602), in step S1603, the CPU 212 executes enumeration processing for operating as a USB device apparatus. Thereafter, the MFP 100 is put in a state in which it is able to communicate with the mobile terminal 104, which is a USB host apparatus. In other words, this activates and enables the second communication IF (or the second communication mode).

Next, in step S1604, the CPU 212 searches for whether or not the system is in a state of being battery powered by the power unit. In the present embodiment, an API for checking the power source state is provided by the embedded OS that controls the entire system of the MFP 100, and whether or not the system is in a battery-powered state can be determined by a program executed by the CPU 212. Also, in addition to whether or not the system is in a battery-powered state, if the system is in a battery-powered state, the charge level can be determined.

In a case where the MFP 100 is in a battery-powered state (yes in step S1604), in step S1605 onward, the CPU 212, after temporarily disconnecting the wireless infrastructure connection with the AP 101, executes processing to reconnect to the AP 101 with Agile Multiband set to disabled. Specifically, in step S1604, in a case where it is determined that the system is in a battery-powered state, in step S1605, the CPU 212 disconnects the WLAN connection with the AP 101. Thereafter, in step S1606, the CPU 212 generates association request data including information indicating that IEEE 802.11v is not supported. This is transmitted to the connection destination AP (AP 101) disconnected in step S1605, and reconnection processing is executed (step S1607).

Lastly, in a case where the CPU 212 determines whether or not a predetermined end condition such as transition to a power saving mode or the pressing of a power button has been established and determines that it is not established (no in step S1608), the processing returns to step S1602 for again detecting a change in the USB connection state via a user operation.

According to the processing described above, when a connection via a USB cable, that is, activation or enabling of a USB communication function, is detected while connected to the AP 101 via wireless infrastructure, Agile Multiband is disabled. In this manner, processing in conjunction with an AP switch request that are assumed to be unnecessary can be suppressed. Accordingly, the processing load and the power consumption can be reduced and resources for other processing such as printing processing via USB can be freed up.

However, take an example of when it is determined that a USB cable is not connected in step S1602. In step S1609, the CPU 212 determines whether or not a USB cable has been removed. In this case also, when the USB unit 232 detects a change in the voltage of a VBUS line generated by the removal of the USB cable as an electrical signal, a VBUS OFF interrupt is generated, and the CPU 212 detects the VBUS OFF interrupt and determines that the USB cable has been removed. Then, when it is determined that the USB cable has been removed, in other words, the USB communication function has ended or been disabled (yes in step S1609), in step S1610, the CPU 212 executes processing for disconnection such as disabling NAK interrupt, suspending USB device tasks, and the like.

Next, in step S1611 onward, if there is a wireless infrastructure connection with the AP 101, the CPU 212 temporarily disconnects this connection before executing processing to reconnect to the AP 101 with Agile Multiband set to enabled. Specifically, in step S1611, the CPU 212 determines whether it is currently connected to the AP 101 via WLAN with IEEE 802.11v in a disabled state. In other words, it is determined whether Agile Multiband is disabled via the WLAN connection with the AP 101. This determination, for example, may be performed on the basis of the IEEE 802.11v enabled/disabled (supported/no supported) stored at the time of connection in association with the SSID.

In step S1611, in a case where it is determined that the CPU 212 is connected to the AP 101 with IEEE 802.11v in a disabled state, in step S1612, the CPU 212 disconnects the WLAN connection with the AP 101. Thereafter, in step S1613, the CPU 212 generates association request data including information indicating that IEEE 802.11v is supported. This is transmitted to the connection destination AP (AP 101) disconnected in step S912, and reconnection processing is executed (step S1614).

Via the processing described above, when the removal of the USB cable is detected while connected to the AP 101 via wireless infrastructure, by re-enabling Agile Multiband, measurement (AP search) in response to a measurement request can be performed and a response to the measurement request can be sent.

Also, in a modified example, in step S1604, the CPU 212 may be configured so that the processing branches at step S1605 only when the remaining amount of battery is equal to or less than a predetermined value, and the processing up until step S1607 disables Agile Multiband. In a case where the remaining amount of battery is greater than the predetermined value, the processing may branch at step S1608.

Also, the second communication interface is not limited to a wireless direct connection or a USB connection and may be a wireless infrastructure mode for connecting to AP 2, different from AP 1, or a wired LAN.

As described above, according to the present embodiment, even with a configuration in which a USB connection with a host apparatus is allowed while an electronic device such as an MFP is connected to an AP in the wireless infrastructure mode, only during simultaneous operation can the wireless infrastructure mode Agile Multiband be disabled. Accordingly, AP switching due to Agile Multiband is prevented, and stable communication operations are guaranteed even for a USB connection during simultaneous operation. Also, when a slave station electronic device is recognized as not supporting IEEE 802.11v by an AP, transmission to the slave station electronic device of a measurement request from the AP is prevented. Thus, measurement (AP search) in response to the measurement request of the slave station electronic device and responding to the measurement request can also be suppressed. Accordingly, effects including the processing load and the power consumption being reduced and resources for other processing being freed up can be achieved.

In the present embodiment described above, for the second communication interface (also referred to as communication mode or communication media) according to the second embodiment, WFD is substituted with USB. However, no such limitation is intended, and the WFD which is the second communication interface described in the first embodiment and the third to fifth embodiment may be substituted with USB in the same manner as in the sixth embodiment. In the case of such substitution, the Agile Multiband setting of the wireless infrastructure mode, which is the first communication interface, can be essentially disabled while there is a connection via USB, which is the second communication interface. Essentially disabled includes, in addition to being set to disabled, a pseudo response being sent in response to a measurement request based on the Agile Multiband setting and a switch request being rejected or ignored.

Also, the second communication interface is not limited to being WFD or USB and another communication medium may be used. For example, the second communication interface may be communication media such as Bluetooth (registered trademark), LTE, NR, wireless LAN, wired LAN, short-range wireless communication, or the like.

Note that the various types of control according to the first to sixth embodiment described above performed by the CPU 212 may be performed by a single piece of hardware or the processing may be shared by a plurality of pieces of hardware (for example, a plurality of processors and circuits) to perform control of the entire apparatus.

Also, preferred embodiments according to the present disclosure have been described above. However, the present disclosure is not limited to these specific embodiments and include various embodiments without departing from the scope of the claims. Furthermore, the embodiments described above are each merely embodiments of the present disclosure, and the embodiments can be combined as appropriate.

Also, in the embodiment described above, an example of the present disclosure applied to an MFP has been described. However, no such limitation is intended, and any communication apparatus that can connect to an external apparatus via a different communication interface while simultaneously being connected to an AP in the wireless infrastructure mode may be used. In other words, the present disclosure is applicable to a personal computer, a PDA, a tablet terminal, a smartphone or similar mobile phone terminal, a music player, a game console, an electronic book reader, a smartwatch, and various types of measurement apparatuses (sensor apparatuses) such as a thermometer and a hygrometer. Also, the present disclosure is applicable to a digital camera (including a still camera, a video camera, a network camera, and a security camera), a printer, a scanner, and a drone. Also, the present disclosure is applicable to an image output apparatus, an audio output apparatus (for example, a smart speaker), a media streaming player, and a wireless LAN client (adapter) that can connect to a USB terminal or a LAN cable terminal. An image output apparatus includes an apparatus, for example, that obtains (downloads) moving images from the Internet specified by a URL in an instruction from an electronic device and outputs these to a display device connected via a HDMI (registered trademark) image output terminal or the like to achieve streaming playback on the display device, achieve mirroring display (causing the display device to also display the content displayed on the electronic device), and the like. Also, the image output apparatus includes a television, hard disk recorder, Blu-ray recorder, DVD recorder, or similar media player; a head-mounted display, a projector, a television, a display apparatus (monitor), and a signage apparatus. Also, the present disclosure is applicable to a device that can connect via Wi-Fi to an air conditioner, a refrigerator, a washing machine, a vacuum cleaner, an open, an electronic microwave, a lighting fixture, a heating device, a cooling device, or any so-called smart home appliances.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-095380, filed Jun. 12, 2024 which is hereby incorporated by reference herein in its entirety.

What is claimed is:

1. An electronic device that can execute communication in a first communication mode via wireless communication with an external access point and execute communication in a second communication mode via wireless communication with an external apparatus, the second communication mode being different from the first communication mode, comprising:
at least one memory storing instructions; and
at least one processor that is in communication with the at least one memory and that, when executing the instructions, cooperates with the at least one memory to execute processing, the processing including
changing an access point of a connection destination connected with the first communication mode to another access point based on a change request received from the access point, and
suppressing a change of an access point of a connection destination based on the change request in a case where a connection in the first communication mode is established and the second communication mode is activated.

2. The electronic device according to claim 1, wherein execution of the instructions
further configures the at least one processor to perform further processing that includes in a case where a connection in the first communication mode is established
when the second communication mode is activated,
cancelling a connection with the access point of a connection destination connected with the first communication mode,
disabling a connection destination access point change function based on the change request, and
connecting to the access point.

3. The electronic device according to claim 2, execution of the instructions further configures the at least one processor to perform further processing that includes
in a case where a connection in the first communication mode is established and the second communication mode is activated, when the second communication mode is ended,
cancelling a connection with the access point of a connection destination connected with the first communication mode,
enabling a connection destination access point change function based on the change request, and
connecting to the access point.

4. The electronic device according to claim 1, execution of the instructions further configures the at least one processor to perform further processing that includes
in a case where a connection in the first communication mode is established and the second communication mode is activated, in response to the change request received from the access point, sending no response or a reject response.

5. The electronic device according to claim 4, execution of the instructions further configures the at least one processor to perform further processing that includes
in a case where the second communication mode is ended after no response or a reject response is sent in response to the change request,
cancelling a connection with the access point of a connection destination connected with the first communication mode,
enabling a connection destination access point change function based on the change request, and
connecting to the access point.

6. The electronic device according to claim 1, execution of the instructions further configures the at least one processor to perform further processing that includes further includes
in a case where a connection in the first communication mode is established and the second communication mode is activated, and in response to a radio field intensity measurement request received from the access point,
sending a pseudo response indicating that no access point exists with a better communication state than the access point currently connected.

7. The electronic device according to claim 1, execution of the instructions further configures the at least one processor to perform further processing that includes
in a case where the second communication mode is set, the second communication mode is activated, and the first communication mode is set,
disabling a connection destination access point change function based on the change request and connecting to the access point.

8. The electronic device according to claim 7, execution of the instructions further configures the at least one processor to perform further processing that includes
in a case where the second communication mode is not set and the first communication mode is set, enabling a connection destination access point change function that is based on the change request, and connecting to the access point.

9. The electronic device according to claim 1, wherein
the second communication mode is at least one of wireless direct communication with the electronic device as a master station, wired LAN communication, USB communication, and short-range wireless communication.

10. The electronic device according to claim 1, further comprising:
a battery that provides a power source for the electronic device,
wherein execution of the instructions further configures the at least one processor to perform further processing that includes
performing control to suppress a connection destination access point change that is based on the change request when in a state of being powered by the battery, and not suppressing a connection destination access point change that is based on the change request when in a state of not being powered by the battery.

11. The electronic device according to claim 10, execution of the instructions further configures the at least one processor to perform further processing that includes
obtaining a remaining amount of charge in the battery, and
in a case where the remaining amount of charge in the battery is equal to or less than a predetermined value, performing control to suppress a connection destination access point change that is based on the change request, and in a case where the remaining amount of the battery is greater than the predetermined value, not suppressing a connection destination access point change that is based on the change request.

12. The electronic device according to claim 1, wherein execution of the instructions further configures the at least one processor to perform further processing that includes
in a case where a connection in the first communication mode is established and a connection in the second communication mode is not established, when the change request is received,
changing the access point of the connection destination connected with the first communication mode to an access point according to the change request on a basis of the change request.

13. The electronic device according to claim 12, wherein
the change request is based on a protocol specified in IEEE 802.11v.

14. The electronic device according to claim 1, wherein
communication in the first communication mode and communication in the second communication mode are both wireless LAN communication.

15. The electronic device according to claim 1, wherein
the electronic device executes connection and processing compliant with an IEEE 802.11ax standard with an access point as processing in the first communication mode.

16. The electronic device according to claim 1, wherein
the electronic device can execute at least one of processing compliant with orthogonal frequency-division multiple access (OFDMA) and processing compliant with target wake time (TWT) as processing in the first communication mode.

17. The electronic device according to claim 1, wherein
the electronic device can change a connection destination to an access point of 6 GHz band by changing a connection destination based on the change request as processing in the first communication mode.

18. The electronic device according to claim 1, further comprising:
a printer that prints an image on a print medium.

19. A control method for an electronic device that can execute communication in a first communication mode via wireless communication with an external access point and execute communication in a second communication mode with an external apparatus, the second communication mode being different from the first communication mode, the control method comprising
changing an access point of a connection destination connected with the first communication mode to another access point on a basis of a change request received from the access point, and
performing control to suppress a change of an access point of a connection destination based on the change request in a case where a connection of the first communication mode is established and the second communication mode is activated.

20. A non-transitory computer-readable storage medium storing a program that when executed causes an electronic device that
executes communication in a first communication mode via wireless communication with an external access point and executes communication in a second communication mode with an external apparatus, the second communication mode different being from the first communication mode, to execute processing including
changing an access point of a connection destination connected with the first communication mode to another access point on a basis of a change request received from the access point, and
suppressing a change of an access point of a connection destination based on the change request in a case where a connection of the first communication mode is established and the second communication mode is activated.
